(19) United States
(12) Patent Application Publication
(10) Pub. No.: US 2025/0317574 A1
(43) Pub. Date: Oct. 9, 2025

(54) OPTICAL CORRECTION SEI MESSAGE FOR VIDEO CODING

(71) Applicant: TENCENT AMERICA LLC, Palo Alto, CA (US)

(72) Inventors: Stephan Wenger, Hillsborough, CA (US); Arianne Hinds, Palo Alto, CA (US)

(21) Appl. No.: 19/171,805

(22) Filed: Apr. 7, 2025

Related U.S. Application Data
(60) Provisional application No. 63/631,899, filed on Apr. 9, 2024.

(51) Int. Cl. H04N 19/147; H04N 19/70

(52) U.S. Cl. CPC H04N 19/147; H04N 19/70

(57) ABSTRACT

There is provided a method for video encoding and decoding based on a picture of a video and a supplementary enhancement information (SEI) message which is associated with the at least one picture and indicates one or more parameters of an optical correction to be applied to the at least one picture.

### CROSS REFERENCE TO RELATED APPLICATION

The present application claims priority to provisional application U.S. 63/631,899 filed on Apr. 9, 2024, the contents of which are hereby expressly incorporated by reference, in its entirety, into the present application.

### BACKGROUND

### 1. Field

The disclosed subject matter relates to video coding and decoding, and more specifically, to the syntax and semantics of a Supplementary Enhancement Information (SEI) message codifying optical correction parameters.

### 2. Description of Related Art

Video coding and decoding using inter-picture prediction with motion compensation has been known for decades. Uncompressed digital video can consist of a series of pictures, each picture having a spatial dimension of, for example, 1920×1080 luminance samples and associated chrominance samples. The series of pictures can have a fixed or variable picture rate (informally also known as frame rate), of, for example 60 pictures per second or 60 Hz. Uncompressed video has significant bitrate requirements. For example, 1080p60 4:2:0 video at 8 bit per sample (1920×1080 luminance sample resolution at 60 Hz frame rate) requires close to 1.5 Gbit/s bandwidth. An hour of such video requires more than 600 GByte of storage space.

One purpose of video coding and decoding can be the reduction of redundancy in the input video signal, through compression. Compression can help reducing aforementioned bandwidth or storage space requirements, in some cases by two orders of magnitude or more. Both lossless and lossy compression, as well as a combination thereof can be employed. Lossless compression refers to techniques where an exact copy of the original signal can be reconstructed from the compressed original signal. When using lossy compression, the reconstructed signal may not be identical to the original signal, but the distortion between original and reconstructed signal is small enough to make the reconstructed signal useful for the intended application. In the case of video, lossy compression is widely employed. The amount of distortion tolerated depends on the application; for example, users of certain consumer streaming applications may tolerate higher distortion than users of television contribution applications. The compression ratio achievable can reflect that: higher allowable/tolerable distortion can yield higher compression ratios.

A video encoder and decoder can utilize techniques from several broad categories, including, for example, motion compensation, transform, quantization, and entropy coding, some of which will be introduced below.

Optical correction of source or reconstructed video, including some of the models referred to below, has been known for decades. An image or video transmission chain can comprise a camera, coupled to an encoder, network, decoder, and rendering device such as a screen. The camera can include a lens and/or other optical elements that may distort the optical input from the rectilinear representation sometimes expected by the screen in certain ways, as described later. In some cases, for example in cost efficient action cameras, such cameras do not include compensation technology to form a true rectilinear representation of the captured scene. Without compensation of the artifacts introduced by the optical elements at the camera or the renderer, the rendered pictures may look distorted. As every camera may have different distortion, parameters need to be devised and conveyed from encoder via transmission chain and decoder to the renderer to instruct the renderer to compensate for the distortion introduced by the optical elements in the camera. Certain distortions from the rectilinear representation may also be introduced by technology outside cameras for, for example, artistic intendent, and such distortion equally may need to be compensated at the renderer.

Common forms of distortion include barrel or pincushion distortion as often found when using fish-eye or wide angle lenses in cameras, chromatic aberration as the result of different diffraction of light of different wavelengths/colors in a lens, vignetting (non-linear light transfer characteristics), and others. And optical correction of source or reconstructed video, including some of the models referred to below, has been known for decades, but particular application in the context of SEI messages and particular useful implementations thereof have been absent.

As such, there is a technical problem in the context of video encoding and decoding of which SEI messages may be of particular use, and embodiments herein provide such solution.

### SUMMARY

There is included a method and apparatus comprising memory configured to store computer program code and a processor or processors configured to access the computer program code and operate as instructed by the computer program code. The computer program is configured to cause the processor implement performing a conversion between a visual media file and a bitstream of a visual media data according to a format rule, the format rule indicating to: determine one or more parameters of an optical correction to be applied to the at least one picture of a video, and to determine the one or more parameters based on a supplementary enhancement information (SEI) message associated with the at least one picture

There is provided a method and apparatus thereof for video decoding in a decoder, the method including: receiving a video bitstream including at least one picture of a video and a supplementary enhancement information (SEI) message associated with the at least one picture; obtaining, from the SEI message, metadata indicating one or more parameters of an optical correction to be applied to the at least one picture; and decoding and applying the optical correction to the picture based on the one or more parameters of the optical correction.

There is provided a method and apparatus thereof of video encoding, the method including: receiving a video including at least one picture; determining an optical correction to be applied to the at least one picture; and encoding the at least one picture and a supplementary enhancement information (SEI) message associated with the at least one picture, the SEI message indicating one or more parameters of an optical correction to be applied to the at least one picture.

The SEI message may include lens optical correction (loc) SEI message syntax of “lens_optical_correction”.

The metadata may further indicate that the one or more parameters of the optical correction are to be applied based on any of radial distortion, chromatic aberration, and vignetting of the picture.

The loc SEI message syntax further may include a plurality of flags each respectively indicating whether the optical correction includes correction to radial distortion, chromatic aberration, and vignetting.

The SEI message may further indicate a first focal center of the picture along a first axis, a second focal center of the picture along a second axis, and a focal length. The SEI message may further indicate a lens model.

The SEI message may further indicate a set of parameters, including the one or more parameters, of at least one model by which the optical correction is to be applied to the at least one picture.

### BRIEF DESCRIPTION OF THE DRAWINGS

Further features, nature, and various advantages of the disclosed subject matter will be more apparent from the following detailed description and the accompanying drawings in which:

FIG. 1 is a schematic illustration of a simplified block diagram of a communication system in accordance with one or more embodiments;

FIG. 2 is a schematic illustration of a simplified block diagram of a communication system in accordance with one or more embodiments;

FIG. 3 is a schematic illustration of a simplified block diagram of a decoder in accordance with one or more embodiments;

FIG. 4 is a schematic illustration of a simplified block diagram of an encoder in accordance with one or more embodiments;

FIG. 5 is a schematic illustration of NAL unit and SEI headers in accordance with one or more embodiments;

FIG. 6 is a schematic illustration of a source and optically distorted image in accordance with one or more embodiments;

FIG. 7 is a schematic illustration of a model in accordance with one or more embodiments;

FIGS. 8A and 8B are schematic illustrations of chromatic aberration in accordance with one or more embodiments;

FIG. 9 is a schematic illustration of video transmission system in accordance with one or more embodiments;

FIG. 10 illustrates an example of parameters from a config file as a sample configuration for lens optical correction SEI according to embodiments;

FIG. 11 illustrates examples 1100 of radial distortion correction being implemented according to embodiments herein;

FIG. 12 illustrates an example of transversal chromatic aberration (TCA) correction being implemented according to embodiments herein; and

FIG. 13 is a schematic illustration of a computer system in accordance with one or more embodiments.

### DETAILED DESCRIPTION

The proposed features discussed below may be used separately or combined in any order. Further, the embodiments may be implemented by processing circuitry (e.g., one or more processors or one or more integrated circuits). In one example, the one or more processors execute a program that is stored in a non-transitory computer-readable medium.

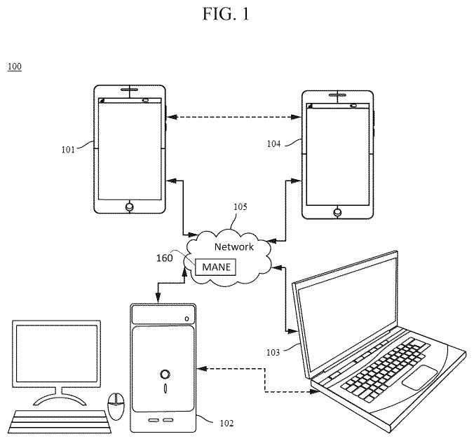

FIG. 1 illustrates a simplified block diagram of a communication system 100 according to an embodiment of the present disclosure. The communication system 100 may include at least two terminals 102 and 103 interconnected via a network 105. For unidirectional transmission of data, a first terminal 103 may code video data at a local location for transmission to the other terminal 102 via the network 105. The second terminal 102 may receive the coded video data of the other terminal from the network 105, decode the coded data and display the recovered video data. Unidirectional data transmission may be common in media serving applications and the like.

FIG. 1 illustrates a second pair of terminals 101 and 104 provided to support bidirectional transmission of coded video that may occur, for example, during videoconferencing. For bidirectional transmission of data, each terminal 101 and 104 may code video data captured at a local location for transmission to the other terminal via the network 105. Each terminal 101 and 104 also may receive the coded video data transmitted by the other terminal, may decode the coded data and may display the recovered video data at a local display device.

In FIG. 1, the terminals 101, 102, 103 and 104 may be illustrated as servers, personal computers and smart phones but the principles of the present disclosure are not so limited. Embodiments of the present disclosure find application with laptop computers, tablet computers, media players and/or dedicated video conferencing equipment. The network 105 represents any number of networks that convey coded video data among the terminals 101, 102, 103 and 104, including for example wireline and/or wireless communication networks. The communication network 105 may exchange data in circuit-switched and/or packet-switched channels. Representative networks include telecommunications networks, local area networks, wide area networks and/or the Internet. For the purposes of the present discussion, the architecture and topology of the network 105 may be immaterial to the operation of the present disclosure unless explained herein below. The network (150) may include Media Aware Network Elements (MANEs, 160) that may be included in the transmission path between, for example, terminal (130) and (140). The purpose of a MANE may be selective forwarding of parts of the media data to react to network congestions, media switching, media mixing, archival, and similar tasks commonly performed by a service provider rather than an end user. Such MANEs may be able to parse and react on a limited part of the media conveyed over the network, for example syntax elements related to the network abstraction layer of video coding technologies or standards.

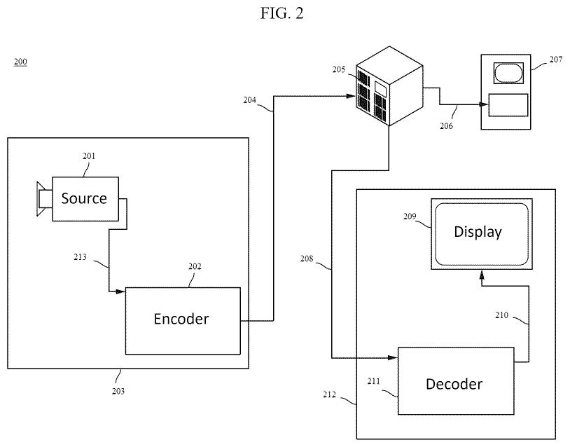

FIG. 2 illustrates, as an example for an application for the disclosed subject matter, the placement of a video encoder and decoder in a streaming environment. The disclosed subject matter can be equally applicable to other video enabled applications, including, for example, video conferencing, digital TV, storing of compressed video on digital media including CD, DVD, memory stick and the like, and so on.

A streaming system may include a capture subsystem 203, that can include a video source 201, for example a digital camera, creating, for example, an uncompressed video sample stream 213. That sample stream 213 may be emphasized as a high data volume when compared to encoded video bitstreams and can be processed by an encoder 202 coupled to the camera 201. The encoder 202 can include hardware, software, or a combination thereof to enable or implement aspects of the disclosed subject matter as described in more detail below. The encoded video bitstream 204, which may be emphasized as a lower data volume when compared to the sample stream, can be stored on a streaming server 205 for future use. One or more streaming clients 212 and 207 can access the streaming server 205 to retrieve copies 208 and 206 of the encoded video bitstream 204. A client 212 can include a video decoder 211 which decodes the incoming copy of the encoded video bitstream 208 and creates an outgoing video sample stream 210 that can be rendered on a display 209 or other rendering device (not depicted). In some streaming systems, the video bitstreams 204, 206 and 208 can be encoded according to certain video coding/compression standards. Examples of those standards are noted above and described further herein. Examples of those standards also include ITU-T Recommendations H.265 and H.266. The disclosed subject matter may be used in the context of VVC for example.

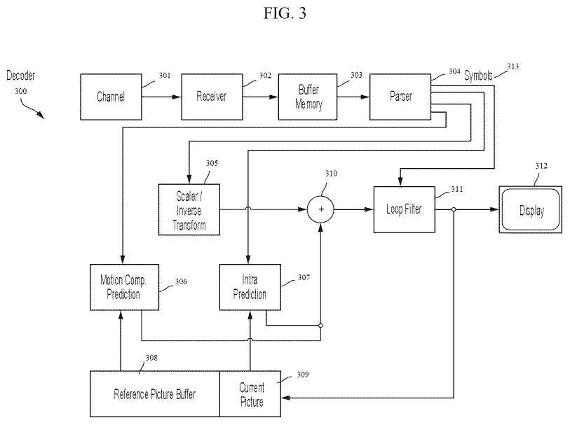

FIG. 3 may be a functional block diagram of a video decoder 300 according to an embodiment of the present invention.

A receiver 302 may receive one or more codec video sequences to be decoded by the decoder 300; in the same or another embodiment, one coded video sequence at a time, where the decoding of each coded video sequence is independent from other coded video sequences. The coded video sequence may be received from a channel 301, which may be a hardware/software link to a storage device which stores the encoded video data. The receiver 302 may receive the encoded video data with other data, for example, coded audio data and/or ancillary data streams, that may be forwarded to their respective using entities (not depicted). The receiver 302 may separate the coded video sequence from the other data. To combat network jitter, a buffer memory 303 may be coupled in between receiver 302 and entropy decoder/parser 304 (“parser” henceforth). When receiver 302 is receiving data from a store/forward device of sufficient bandwidth and controllability, or from an isosychronous network, the buffer 303 may not be needed, or can be small. For use on best effort packet networks such as the Internet, the buffer 303 may be required, can be comparatively large and can advantageously of adaptive size.

The video decoder 300 may include a parser 304 to reconstruct symbols 313 from the entropy coded video sequence. Categories of those symbols include information used to manage operation of the decoder 300, and potentially information to control a rendering device such as a display 312 that is not an integral part of the decoder but can be coupled to it. The control information for the rendering device(s) may be in the form of Supplementary Enhancement Information (SEI messages) or Video Usability Information parameter set fragments (not depicted). The parser 304 may parse/entropy-decode the coded video sequence received. The coding of the coded video sequence can be in accordance with a video coding technology or standard, and can follow principles well known to a person skilled in the art, including variable length coding, Huffman coding, arithmetic coding with or without context sensitivity, and so forth. The parser 304 may extract from the coded video sequence, a set of subgroup parameters for at least one of the subgroups of pixels in the video decoder, based upon at least one parameters corresponding to the group. Subgroups can include Groups of Pictures (GOPs), pictures, tiles, slices, macroblocks, Coding Units (CUs), blocks, Transform Units (TUs), Prediction Units (PUs) and so forth. The entropy decoder/parser may also extract from the coded video sequence information such as transform coefficients, quantizer parameter values, motion vectors, and so forth.

The parser 304 may perform entropy decoding/parsing operation on the video sequence received from the buffer 303, so to create symbols 313. The parser 304 may receive encoded data, and selectively decode particular symbols 313. Further, the parser 304 may determine whether the particular symbols 313 are to be provided to a Motion Compensation Prediction unit 306, a scaler/inverse transform unit 305, an Intra Prediction Unit 307, or a loop filter 311.

Reconstruction of the symbols 313 can involve multiple different units depending on the type of the coded video picture or parts thereof (such as: inter and intra picture, inter and intra block), and other factors. Which units are involved, and how, can be controlled by the subgroup control information that was parsed from the coded video sequence by the parser 304. The flow of such subgroup control information between the parser 304 and the multiple units below is not depicted for clarity.

Beyond the functional blocks already mentioned, decoder 300 can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit 305. The scaler/inverse transform unit 305 receives quantized transform coefficient as well as control information, including which transform to use, block size, quantization factor, quantization scaling matrices, etc. as symbol(s) 313 from the parser 304. It can output blocks comprising sample values, that can be input into aggregator 310.

In some cases, the output samples of the scaler/inverse transform 305 can pertain to an intra coded block; that is: a block that is not using predictive information from previously reconstructed pictures, but can use predictive information from previously reconstructed parts of the current picture. Such predictive information can be provided by an intra picture prediction unit 307. In some cases, the intra picture prediction unit 307 generates a block of the same size and shape of the block under reconstruction, using surrounding already reconstructed information fetched from the current (partly reconstructed) picture 309. The aggregator 310, in some cases, adds, on a per sample basis, the prediction information the intra prediction unit 307 has generated to the output sample information as provided by the scaler/inverse transform unit 305.

In other cases, the output samples of the scaler/inverse transform unit 305 can pertain to an inter coded, and potentially motion compensated block. In such a case, a Motion Compensation Prediction unit 306 can access reference picture memory 308 to fetch samples used for prediction. After motion compensating the fetched samples in accordance with the symbols 313 pertaining to the block, these samples can be added by the aggregator 310 to the output of the scaler/inverse transform unit (in this case called the residual samples or residual signal) so to generate output sample information. The addresses within the reference picture memory form where the motion compensation unit fetches prediction samples can be controlled by motion vectors, available to the motion compensation unit in the form of symbols 313 that can have, for example X, Y, and reference picture components. Motion compensation also can include interpolation of sample values as fetched from the reference picture memory when sub-sample exact motion vectors are in use, motion vector prediction mechanisms, and so forth.

The output samples of the aggregator 310 can be subject to various loop filtering techniques in the loop filter unit 311. Video compression technologies can include in-loop filter technologies that are controlled by parameters included in the coded video bitstream and made available to the loop filter unit 311 as symbols 313 from the parser 304, but can also be responsive to meta-information obtained during the decoding of previous (in decoding order) parts of the coded picture or coded video sequence, as well as responsive to previously reconstructed and loop-filtered sample values.

The output of the loop filter unit 311 can be a sample stream that can be output to the display 312, which may be a render device, as well as stored in the reference picture memory 557 for use in future inter-picture prediction.

Certain coded pictures, once fully reconstructed, can be used as reference pictures for future prediction. Once a coded picture is fully reconstructed and the coded picture has been identified as a reference picture (by, for example, parser 304), the current reference picture 309 can become part of the reference picture buffer 308, and a fresh current picture memory can be reallocated before commencing the reconstruction of the following coded picture.

The video decoder 300 may perform decoding operations according to a predetermined video compression technology that may be documented in a standard, such as ITU-T Rec. H.265 and/or H.266. The coded video sequence may conform to a syntax specified by the video compression technology or standard being used, in the sense that it adheres to the syntax of the video compression technology or standard, as specified in the video compression technology document or standard and specifically in the profiles document therein. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver 302 may receive additional (redundant) data with the encoded video. The additional data may be included as part of the coded video sequence(s). The additional data may be used by the video decoder 300 to properly decode the data and/or to more accurately reconstruct the original video data. Additional data can be in the form of, for example, temporal, spatial, or signal-to-noise ratio (SNR) enhancement layers, redundant slices, redundant pictures, forward error correction codes, and so on.

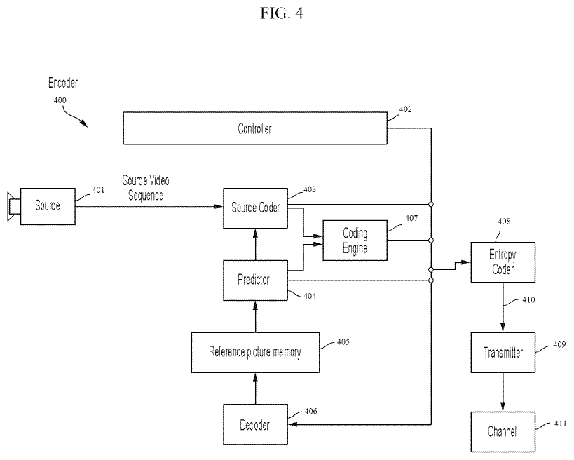

FIG. 4 may be a functional block diagram of a video encoder 400 according to an embodiment of the present disclosure.

The encoder 400 may receive video samples from a video source 401 (that is not part of the encoder) that may capture video image(s) to be coded by the encoder 400.

The video source 401 may provide the source video sequence to be coded by the encoder (303) in the form of a digital video sample stream that can be of any suitable bit depth (for example: 8 bit, 10 bit, 12 bit, . . . ), any colorspace (for example, BT.601 Y CrCB, RGB, . . . ) and any suitable sampling structure (for example Y CrCb 4:2:0, Y CrCb 4:4:4). In a media serving system, the video source 401 may be a storage device storing previously prepared video. In a videoconferencing system, the video source 401 may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. A person skilled in the art can readily understand the relationship between pixels and samples. The description below focuses on samples.

According to an embodiment, the encoder 400 may code and compress the pictures of the source video sequence into a coded video sequence 410 in real time or under any other time constraints as required by the application. Enforcing appropriate coding speed is one function of Controller 402. Controller controls other functional units as described below and is functionally coupled to these units. The coupling is not depicted for clarity. Parameters set by controller can include rate control related parameters (picture skip, quantizer, lambda value of rate-distortion optimization techniques, . . . ), picture size, group of pictures (GOP) layout, maximum motion vector search range, and so forth. A person skilled in the art can readily identify other functions of controller 402 as they may pertain to video encoder 400 optimized for a certain system design.

Some video encoders operate in what a person skilled in the art readily recognizes as a “coding loop.” As an oversimplified description, a coding loop can consist of the encoding part of an encoder (for example a source coder 403) (responsible for creating symbols based on an input picture to be coded, and a reference picture(s)), and a (local) decoder 406 embedded in the encoder 400 that reconstructs the symbols to create the sample data that a (remote) decoder also would create (as any compression between symbols and coded video bitstream is lossless in the video compression technologies considered in the disclosed subject matter). That reconstructed sample stream is input to the reference picture memory 405. As the decoding of a symbol stream leads to bit-exact results independent of decoder location (local or remote), the reference picture buffer content is also bit exact between local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is well known to a person skilled in the art.

The operation of the “local” decoder 406 can be the same as of a “remote” decoder 300, which has already been described in detail above in conjunction with FIG. 3. Briefly referring also to FIG. 4, however, as symbols are available and en/decoding of symbols to a coded video sequence by entropy coder 408 and parser 304 can be lossless, the entropy decoding parts of decoder 300, including channel 301, receiver 302, buffer 303, and parser 304 may not be fully implemented in local decoder 406.

An observation that can be made at this point is that any decoder technology except the parsing/entropy decoding that is present in a decoder also necessarily needs to be present, in substantially identical functional form, in a corresponding encoder. The description of encoder technologies can be abbreviated as they are the inverse of the comprehensively described decoder technologies. Only in certain areas a more detail description is required and provided below.

As part of its operation, the source coder 403 may perform motion compensated predictive coding, which codes an input frame predictively with reference to one or more previously-coded frames from the video sequence that were designated as “reference frames.” In this manner, the coding engine 407 codes differences between pixel blocks of an input frame and pixel blocks of reference frame(s) that may be selected as prediction reference(s) to the input frame.

The local video decoder 406 may decode coded video data of frames that may be designated as reference frames, based on symbols created by the source coder 403. Operations of the coding engine 407 may advantageously be lossy processes. When the coded video data may be decoded at a video decoder (not shown in FIG. 4), the reconstructed video sequence typically may be a replica of the source video sequence with some errors. The local video decoder 406 replicates decoding processes that may be performed by the video decoder on reference frames and may cause reconstructed reference frames to be stored in the reference picture memory 405. which may be for example a cache. In this manner, the encoder 400 may store copies of reconstructed reference frames locally that have common content as the reconstructed reference frames that will be obtained by a far-end video decoder (absent transmission errors).

The predictor 404 may perform prediction searches for the coding engine 407. That is, for a new frame to be coded, the predictor 404 may search the reference picture memory 405 for sample data (as candidate reference pixel blocks) or certain metadata such as reference picture motion vectors, block shapes, and so on, that may serve as an appropriate prediction reference for the new pictures. The predictor 404 may operate on a sample block-by-pixel block basis to find appropriate prediction references. In some cases, as determined by search results obtained by the predictor 404, an input picture may have prediction references drawn from multiple reference pictures stored in the reference picture memory 405.

The controller 402 may manage coding operations of the video coder 403, including, for example, setting of parameters and subgroup parameters used for encoding the video data.

Output of all aforementioned functional units may be subjected to entropy coding in the entropy coder 408. The entropy coder translates the symbols as generated by the various functional units into a coded video sequence, by loss-less compressing the symbols according to technologies known to a person skilled in the art as, for example Huffman coding, variable length coding, arithmetic coding, and so forth.

The transmitter 409 may buffer the coded video sequence(s) as created by the entropy coder 408 to prepare it for transmission via a communication channel 411, which may be a hardware/software link to a storage device which would store the encoded video data. The transmitter 409 may merge coded video data from the video coder 403 with other data to be transmitted, for example, coded audio data and/or ancillary data streams (sources not shown).

The controller 402 may manage operation of the encoder 400. During coding, the controller 405 may assign to each coded picture a certain coded picture type, which may affect the coding techniques that may be applied to the respective picture. For example, pictures often may be assigned as one of the following frame types:

An Intra Picture (I picture) may be one that may be coded and decoded without using any other frame in the sequence as a source of prediction. Some video codecs allow for different types of Intra pictures, including, for example Independent Decoder Refresh Pictures. A person skilled in the art is aware of those variants of I pictures and their respective applications and features.

A Predictive picture (P picture) may be one that may be coded and decoded using intra prediction or inter prediction using at most one motion vector and reference index to predict the sample values of each block.

A Bi-directionally Predictive Picture (B Picture) may be one that may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

The video coder 400 may perform coding operations according to a predetermined video coding technology or standard, such as ITU-T Rec. H.265 and/or H.266. In its operation, the video coder 400 may perform various compression operations, including predictive coding operations that exploit temporal and spatial redundancies in the input video sequence. The coded video data, therefore, may conform to a syntax specified by the video coding technology or standard being used.

In an embodiment, the transmitter 409 may transmit additional data with the encoded video. The source coder 403 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and so on.

Compressed video can be augmented, in the video bitstream, by supplementary enhancement information, for example in the form of Supplementary Enhancement Information (SEI) Messages or Video Usability Information (VUI). Video coding standards can include specifications parts for SEI and VUI. SEI and VUI information may also be specified in stand-alone specifications that may be referenced by the video coding specifications.

According to embodiments herein, the processes both of encoding and of decoding may each be considered to be processing of visual media data performing a conversion between a visual media file and a bitstream of a visual media data according to a format rule.

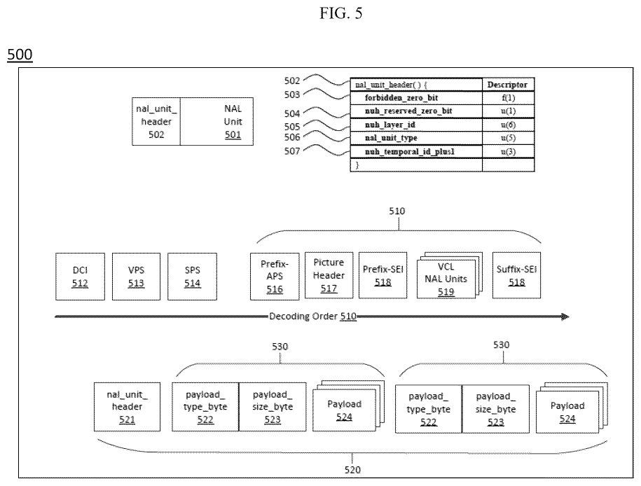

Referring to FIG. 5, shown is an example 500 of an exemplary layout of a Coded Video Sequence (CVS) in accordance with H.266 and embodiments herein. The coded video sequence is subdivided into Network Abstraction Layer units (NAL units). An exemplary NAL unit 501 can include a NAL unit header 502, which in turn comprises 16 bits as follows: a forbidden_zero_bit 503 and nuh_reserved_zero_bit 504 may be unused by H.266 and may be zero in a NAL unit compliant with H.266. Three bits of nuh_layer_id 505 may be indicative of the (spatial, SNR, or multiview enhancement) layer to which the NAL unit belongs. Five bits of nuh_nal_unit_type 506 define the type of NAL unit. In H.266 according to embodiments herein, 22 NAL unit type values are defined for NAL unit types, six NAL unit types are reserved, and four NAL unit type values are unspecified and can be used by specifications other than H.266. Finally, three bits of the NAL unit header 502 indicate the temporal layer to which the NAL unit belongs nuh_temporal_id_plus1 506.

A coded picture may contain one or more Video Coding Layer (VCL) NAL units and zero or more non-VCL NAL units. VCL NAL units may contain coded data conceptually belonging to a video coding layer as introduced before. Non-VCL NAL units may contain data conceptually belonging data not conceptually belonging to the video coding layer. Using H.266 as an example, those units can be categorized into parameter sets, picture header, NAL units, Prefix and Suffix SEI Nal unit types, Filler Data NAL unit type FD_NUT, and Reserved and Unspecified NAL unit types.

(1) Parameter sets, which comprise information that can be necessary for the decoding process and can apply to more than one coded picture. Parameter sets and conceptually similar NAL units may be of NAL unit types such as DCI_NUT (Decoding Capability Information (DCI)), VPS_NUT (Video Parameter Set (VPS), establishing, among other things, layer relationships), SPS_NUT (Sequence Parameter Set (SPS), establishing, among other things, parameters used and staying constant throughout a coded video sequence CVS), PPS_NUT (Picture Parameter Set (PPS), establishing, among other things, parameter used and staying constant within a coded picture), and PREFIX_APS_NUT and SUFFIX_APS_NUT (prefix and suffix Adaptation Parameter Sets). Parameter sets may include information required for a decoder to decode VCL NAL units, and hence are referred here as “normative” NAL units.

(2) Picture Header (PH_NUT), which is also a “normative” NAL unit.

(3) NAL units marking certain places in a NAL unit stream. Those include NAL units with the NAL unit types AUD_NUT (Access Unit Delimiter), EOS_NUT (End of Sequence) and EOB_NUT (End of Bitstream). These are non-normative, also known as informative, in the sense that a compliant decoder does not require them for its decoding process, although it needs to be able to receive them in the NAL unit stream.

(4) Prefix and Suffix SEI Nal unit types (PREFIX_SEI_NUT and SUFFIX_SEI_NUT) which indicate NAL units containing Prefix and Suffix supplementary enhancement information. IN H.266 (April 2022), those NAL units are informative, as they are not required for the decoding process.

(5) Filler Data NAL unit type FD_NUT indicates filler data; data that can be random and can be used to “waste” bits in a NAL unit stream or bitstream, which may be necessary for the transport over certain isochronous transport environments.

(6) Reserved and Unspecified NAL unit types.

Still referring to FIG. 5, shown is a layout of a NAL unit stream in decoding order 510 containing a coded picture 511 containing NAL units of some of the types previously introduced. Somewhere early in the NAL unit stream, DCI 512, VPS 513, and SPS 514 may, in combination, establish the parameters which the decoder can use to decode the coded pictures of a coded video sequence (CVS), including coded picture 511 of the NAL unit stream.

The coded picture 511 can contain, in the depicted order or any other order compliant with the video coding technology or standard in use (here: H.266): a Prefix APS 516, Picture header (PH, 517), prefix SEI 518, one or more VCL NAL units 519, and suffix SEI 520.

Prefix and suffix SEI NAL units 518 and 520 were motivated during the standards development as, for some SEI messages, the content of the message would be known before the coding of a given picture commences, whereas other content would only be known once the picture were coded. Allowing certain SEI messages to appear early or late in a coded picture's NAL unit stream through prefix and suffix SEIs allows avoiding buffering. As one example, in an encoder the sampling time of a picture to be coded is known before the picture is coded, and hence the picture timing SEI message can be a prefix SEI message 516. On the other hand, a decoded picture hash SEI message, which contains a hash of the sample values of a decoded pictures and can be useful, for example, to debug encoder implementations, is a suffix SEI message 518 as an encoder cannot calculate a hash over reconstructed samples before a picture has been coded. The location of Prefix and Suffix SEI NAL units may not be restricted to their position in the NAL unit stream. The phrase “Prefix” and “Suffix” may imply to what coded pictures or NAL units the Prefix/Suffix SEI message may pertain to, and the details of this applicability may be specified, for example in the semantics description of a given SEI message.

Still referring to FIG. 5, shown is a simplified syntax diagram of a NAL unit that contains a prefix or suffix SEI message 520. This syntax can be a container format for multiple SEI messages that can be carried in one NAL unit. Details of the extension mechanism for both payload size and payload type numbering range specified in H.266 are omitted here for clarity. As other NAL units, SEI NAL units start with a NAL unit header 521. The header is followed by one or more SEI messages; two are depicted 530, 531 and described henceforth. Each SEI message inside the SEI NAL unit may include an 8 bit payload_type_byte 522 which specifies one of 256 different SEI types (or extension indication); an 8 bit payload_size_byte 523 which specifies the number of bytes of the SEI payload (or the presence of an extension block), and payload_size-byte number minus 1 bytes of Payload 524. The syntax of the Payload 524 depends on the SEI message, it can be of any length between 0 and 254 bytes unless the extension mechanism is used (not shown), in which case the syntax would allow for unlimited payload sizes.

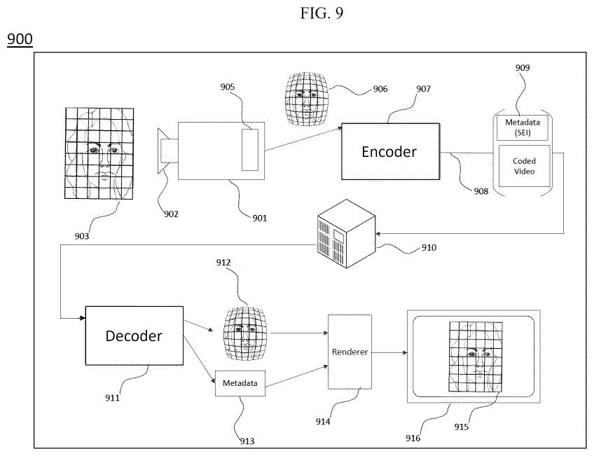

Referring to FIG. 9, shown is a video distribution chain in accordance with embodiments herein. A camera 901 may include a lens 902 or other optical elements creating distortion. The lens may be pointed to an object 903. The images as captured by the sensor 905 may be distorted with effects such as, but not limited to, barrel, pincushion, chromatic aberration, and vignetting distortion. As a possible example, the distorted images as captured by the sensor may look as depicted 906. The distorted images 906 may be fed to an encoder 907, resulting in bitstream 908. Bitstream 908 may include certain metadata, for example coded in the form of SEI messages 909. As the camera 901 is coupled to the encoder 907, the encoder may be aware of the camera characteristics including the distortion that the camera lens 902 may create. The encoder may include camera characteristics, including lens characteristics in the form of one or more SEI messages 909.

Note that lens distortion may change over time, for example when a zoom lens is employed and a user were directing the zoom factor. For example, no substantial distortion may be present if the focus of the zoom lens were set to zoom into a detail far away, while significant distortion may be present when the zoom lens were set to capture an ultra-wide scene in a fish-eye setting.

According to embodiments herein, many implementation-dependent mechanisms can be used to couple camera and encoder to convey camera characteristics including lens characteristics, for example: serial link and standardized or proprietary protocol conveying camera characteristics, inclusion of camera characteristics in the metadata associated with each picture to be encoded, and so forth. Insofar, a mechanism that can convey (updated or original) camera characteristics associated with any given coded picture in the video bitstream is appropriate, and the mechanism to implement metadata at a per-picture granularity can be an SEI message.

Some camera may include hardware or software that transforms the potentially distorted image into a equalizer representation suitable for unmodified display. However, performing the distortion compensation in the camera may have certain drawbacks, and hence it is not universally implemented. A first drawback can be the additional cost and power demands of the processing hardware/software, that may be prohibitive for certain camera such as cost-effective, battery powered and lightweight action cameras. A second drawback can be that a compensated picture may not be rectangular—or, if it were padded to be rectangular, may contain samples artificially generated and unrelated to the object captured. From viewing this disclosure, other drawbacks are apparent to a person skilled in the art.

Returning to FIG. 9, the bitstream 908 including the SEI message(s) 909 may be stored, for example on a server 910 or locally on a memory device, or conveyed directly to the decoder 911. The decoder may receive the bitstream 908 accordingly and may decode it into a series of reconstructed pictures 912 (only one reconstructed picture is depicted), and associated metadata 913. The associated metadata may include camera characteristics metadata. The decoder may forward the camera metadata to a renderer 914. The precise mechanism of such forwarding may be, once more, implementation dependent. The forwarding could use a network, serial link, inclusion in metadata associated with each picture, and so forth. Also, in some cases, decoder 911 and renderer 914 can be closely integrated in the same hardware/software structures and hence the data structures reconstructed by the decoder 911, including metadata, may be directly accessible by the renderer 914.

The renderer 914 may use the information conveyed in the metadata 913 to modify the reconstructed pictures 912 so to generate a compensated and visually pleasing output picture 915 to be shown on display 916 or used on other ways.

Three exemplary types of distortions and mechanisms to combat such distortions are introduced below. Such mechanism can be implemented and applied in isolation, sequentially in any order, or combined with each other.

For example, embodiments herein provide for ultra wide angle and fisheye cameras characteristics. Fisheye lenses may have an extremely wide field of view, sometimes exceeding 180 degrees. They may capture a spherical or hemispherical view, including a significant amount of distortion. Such a distortion may result in either barrel distortion (outward curvature) or pincushion distortion (inward curvature) near the edges of the frame. Fisheye lenses also may have very short focal lengths. The shorter the focal length, the greater potential depth of field.

Ultra-wide-angle lenses have also a wide field of view but do not typically reach the extreme degrees of coverage seen in fisheye lenses. They usually provide a field of view between 90 degrees and 120 degrees.

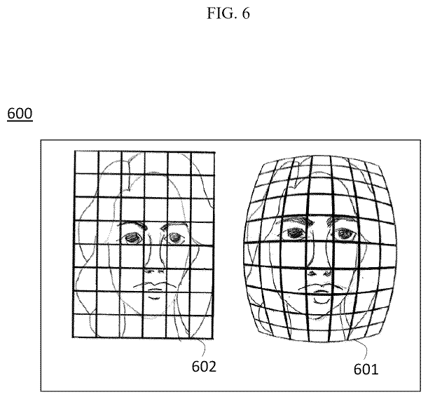

FIG. 6 depicts an example 600 of the distortion that can be found when using a ultra-wide angle or fish-eye lens. Consider image (in a sequence of images) on the right 601, depicting a head of a person behind a square mesh, and captured by a fish-eye lens. The image is visually distorted; it is not square, the head is bloated in the centered and overly narrow on the edges, and so forth. After correction using appropriate parameters, the corrected image on the left 602 looks natural and visually pleasing.

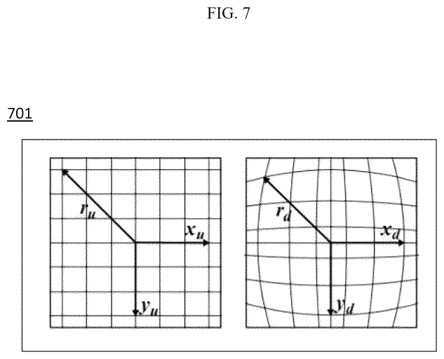

The radial distortion introduced by wide angle optics can be corrected with various correction models. Referring to FIG. 7, those models express the relation 701 between the distance of a point (pixel) from the focal point (usually the center of the image) in the distorted image (noted r_{d}) and in the undistorted image (noted rᵤ).

In that light, notable models include: Poly3 model, Poly5 model, Ptlens model, and Adobe Camera model (ACM) according to embodiments herein.

The Poly3 model is a 3^{rd} order polynomial model, defined as:

$${r}_{d} = {r}_{u} \cdot ( 1 - {k}_{1} + {k}_{1} {r}_{u}^{2} ) \qquad Eq . 1$$

with k₁ being the correction term. k₁ value is in the range [−1,1] with a default value of 0 (i.e., no distortion). When k1>0 the barrel distortion is observed whereas k1<0 corresponds to the pincushion effect.

The Poly5 model is the 5^{th} order polynomial model defined as:

$${r}_{d} = {r}_{u} \cdot ( 1 + {k}_{1} {r}_{u}^{2} + {k}_{2} {r}_{u}^{4} ) \qquad Eq . 2$$

with k₁ being the quadratic correction term, k₂ being the double quadratic term. k₁ and k₂ values range in [−1,1] with a default value of 0 (i.e., no distortion).

The Ptlens model is a more sophisticated model expressed as:

$${r}_{d} = {r}_{u} \cdot ( {ar}_{u}^{3} + {br}_{u}^{2} + {cr}_{u} + 1 - a - b - c ) \qquad Eq . 3$$

with “a”, “b”, and “c” being parameters corresponding to the physical properties of the lens in the range [−1,1] and equal to 0 by default (i.e., no correction).

The Adobe Camera model (ACM) is an even more complex representation model of the lens distortion with a different coordinate system where parameters are applied on units of the focal length of the lens. The model is defined as:

$${x}_{d} = {x}_{u} ( 1 + {k}_{1} {r}_{u}^{2} + {k}_{2} {r}_{u}^{4} + {k}_{3} {r}_{u}^{6} ) + 2 {x}_{u} ( {k}_{4} {y}_{u} + {k}_{5} {x}_{u} ) + {k}_{5} {r}_{u}^{2} , \\ {y}_{d} = {y}_{u} ( 1 + {k}_{1} {r}_{u}^{2} + {k}_{2} {r}_{u}^{4} + {k}_{3} {r}_{u}^{6} ) + 2 {y}_{u} ( {k}_{4} {y}_{u} + {k}_{5} {x}_{u} ) + {k}_{4} {r}_{u}^{2} , \qquad Eq . 4$$

with

$${r}_{u}^{2} = {x}_{u}^{2} + {y}_{u}^{2} . ,$$

the corresponding attributes are called k₁, k₂, k₃, k₄, and k₅ and are by default to 0.

The ACM model is appropriate for correcting fisheye type of lenses by only using the k₁ and k₂ parameters.

With the transmission of an appropriate set of the parameters introduced above, the image can be corrected at the renderer. A syntax and semantics for an SEI message covering models is described below along with various relevant aberrations that may be indicated.

For example, consider chromatic aberration.

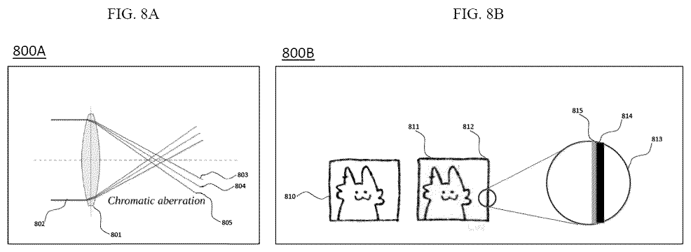

Light is electromagnetic radiation and characterized, among others, by its wavelength. As shown in the example 800A of FIG. 8A, when light rays of different colors are passing through the edge of a lens 801, due to prismatic effects, the rays may be broken at wavelength-dependent angles. For example, red light components 803 of white light 802 may be broken at sharper angles than green components 804, and green components at sharper angles than blue components 805. The characteristics of this prismatic effect depends on the type of material the lens is made of, among other possible factors.

The example 800B of FIG. 8B depicts an example of chromatic aberration. The source 810 may be black and white line art with uniform line weight. Picture 811 may be the result of a capture with a lens having chromatic distortion primarily in the horizontal dimension. Here the horizontal line 812 may have a “shadow” that, when rendered in color, would appear blue. In the black and white rendering herein, that shadow is difficult to see. However, the magnification 813 depicts the black line 814 and the blue shadow 815.

The effect is the cause of chromatic aberration, also known as color fringing, when the colors start to separate at the edges of a picture. Transversal chromatic aberration (TCA) correction can compensate prismatic effects. And according to embodiments herein, there are several models (such as Linear TCA model, 3^{rd} order polynomial TCA model, and Adobe camera model TCA model), that may take the green component as the reference and attempt to align the red and blue with it.

The Linear TCA model may be expressed as:

$${r}_{d , R} = {r}_{u , R} {k}_{R} \\ {r}_{d , B} = {r}_{u , B} {k}_{B} \qquad Eq . 5$$

where r_{d,R} and r_{d,B} are respectively the red and blue coordinates of a point in the distorted image, r_{u,R} and r_{u,B} respectively the red and blue coordinates in the undistorted corrected image, kᵣ and k_{b} the TCA parameters that default to 1.

The 3^{rd} order polynomial TCA model may be expressed as:

$${r}_{d , R} = {r}_{u , R} \cdot ( {b}_{B} {r}_{u , R}^{2} + {c}_{R} {r}_{u , R} + {v}_{R} ) \\ {r}_{d , B} = {r}_{u , B} \cdot ( {b}_{B} {r}_{u , B}^{2} + {c}_{B} {r}_{u , B} + {v}_{B} ) \qquad Eq . 6$$

where r_{d,R} and r_{d,B} are respectively the red and blue coordinates of a point in the distorted image, r_{u,R} and r_{u,B} respectively the red and blue coordinates in the undistorted corrected image, b_{R}, c_{R}, v_{R}, b_{B}, v_{B}, and v_{B} the TCA parameters that default to 1.

The Adobe camera model TCA model may be expressed as:

$${x}_{d , R} = {α}_{0} ( ( 1 + {α}_{1} {r}_{u , R}^{2} + {α}_{2} {r}_{u , R}^{4} + {α}_{3} {r}_{u , R}^{6} ) {x}_{u , R} + 2 ( {α}_{4} {y}_{u , R} + {α}_{5} {x}_{u , R} ) {x}_{u , R} + {α}_{5} {r}_{u , R}^{2} ) , \\ {y}_{d , R} = {α}_{0} ( ( 1 + {α}_{1} {r}_{u , R}^{2} + {α}_{2} {r}_{u , R}^{4} + {α}_{3} {r}_{u , R}^{6} ) {y}_{u , R} + 2 ( {α}_{4} {y}_{u , R} + {α}_{5} {x}_{u , R} ) {y}_{u , R} + {α}_{5} {r}_{u , R}^{2} ) , \\ {x}_{d , B} = {β}_{0} ( ( 1 + {β}_{1} {r}_{u , B}^{2} + {β}_{2} {r}_{u , B}^{4} + {β}_{3} {r}_{u , B}^{6} ) {x}_{u , B} + 2 ( {β}_{4} {y}_{u , B} + {β}_{5} {x}_{u , B} ) {x}_{u , B} + {β}_{5} {r}_{u , B}^{2} ) , \\ {y}_{d , B} = {β}_{0} ( ( 1 + {β}_{1} {r}_{u , B}^{2} + {β}_{2} {r}_{u , B}^{4} + {β}_{3} {r}_{u , B}^{6} ) {y}_{u , B} + 2 ( {β}_{4} {y}_{u , B} + {β}_{5} {x}_{u , B} ) {y}_{u , B} + {β}_{5} {r}_{u , B}^{2} ) , \qquad Eq . 7$$

where

$${r}_{u , *} = \sqrt{{x}_{u , *}^{2} + {y}_{u , *}^{2}} ,$$

(x_{d,R},y_{d,R}) and (x_{d,B},y_{d,B}) are respectively the red and blue coordinates of a point in the distorted image, r_{u,R} and r_{u,B} respectively the red and blue coordinates in the undistorted corrected image, b_{R}, c_{R}, v_{R}, b_{B}, v_{B}, and v_{B} the TCA parameters that default to 1.

Embodiments herein also consider Vignetting. Vignetting is the effect of light fall-off in the corners of images due to lens characteristics. The vignetting effect can be modelled as a dome applied on the picture. In some cases, the amount of vignetting is not noticeable. However, even small amounts of vignetting can be a problem after videos are stitched into a 360 mode, when dark bands become evident at the stitching edges, or in machine processing scenarios, or certain other applications. A vignetting correction (su can operate only on the brightness distribution within a video, e.g., using one of popular models (e.g., The Pablo D'Angelo (PA) Vignetting model and/or The Adobe's (ACM) vignetting model).

The Pablo D'Angelo (PA) Vignetting model may be specified as:

$${C}_{d} = {C}_{s} / ( 1 + {k}_{1} {r}^{2} + {k}_{2} {r}^{4} + {k}_{3} {r}^{6} ) \qquad Eq . 8$$

with C_{d} referring to the corrected destination image pixel brightness, Cₛ referring to the uncorrected source image pixel brightness, k₁, k₂ and k₃ referring to the polynomial parameters of the correction.

The Adobe's (ACM) vignetting model may be specified as:

$${C}_{d} = {C}_{s} / ( 1 + {α}_{1} {r}^{2} + {α}_{2} {r}^{4} + {α}_{3} {r}^{6} ) . \qquad Eq . 9$$

with C_{d} referring to the corrected destination image pixel brightness, Cₛ referring to the uncorrected source image pixel brightness, α₁, α₂ and α₃ referring to the parameters of the correction expressed in units of the focal length.

Information pertaining to the above models can be coded as metadata in a coded video bitstream. As lens parameters may change frequently—for example when zoom lenses are involved—it can be advisable to use a metadata structure that allows association of lens parameters on a coded picture level. One appropriate solution can, therefore, be an SEI message according to embodiments herein.

Below, shown are syntax and semantics of an SEI message that allows conveying information of the models reviewed above according to embodiments herein. A person skilled in the art can easily derive versions of this SEI message supporting only a subset of such models, split the single SEI message into multiple SEI messages covering different models or sets of models, incorporate the information presented in other metadata structures such as the Visual Usability Information structure or in parameter sets or any other syntax structure.

The syntax is presented in the form of a table whose format is known to those familiar with video codecs from the ITU and MPEG. Specifically, on the right side of the table, a c-style syntax is used to show when certain syntax elements are present in the bitstream. Syntax element names are set out boldface. In the Descriptor column, the data type for the syntax element is specified. For example u(1) means a single bit unsigned integer or flag, u(16) means a 16 bit unsigned integer, and so forth. The syntax table uses primarily unsigned integers of appropriate length and hence with appropriate numbering range. A person skilled in the art can easily determine when another data type, for example a variable length integer, may be more appropriate from a coding efficiency viewpoint, and substitute those data types for the fixed length integers. And Table 1 below shows lens optical correction SEI message syntax according to one or more embodiments.

TABLE 1
Lens optical correction SEI message syntax

| | Descriptor |
|---|---|
| lens_optical_correction( payloadSize ) { | |
| loc_{—}cancel_{—}flag | u(1) |
| if( !loc_cancel_flag ) { | |
| loc_{—}focal_{—}parameters_{—}present_{—}flag | u(1) |
| if( loc_focal_parameters_present_flag ) { | |
| loc_{—}focal_{—}center_{—}x | u(16) |
| loc_{—}focal_{—}center_{—}y | u(16) |
| loc_{—}focal_{—}length | u(16) |
| } | |
| loc_{—}radial_{—}distortion_{—}parameters_{—}present_{—}flag | u(1) |
| if( loc_radial_distortion_parameters_present_flag ) { | |
| loc_{—}radial_{—}distortion_{—}model_{—}id | u(8) |
| if( loc_radial_distortion_model==0 ) { | |
| rd_{—}poly3_{—}k1_{—}times1000 | u(16) |
| } | |
| if( loc_radial_distortion_model==1 ) { | |
| rd_{—}poly5_{—}k1_{—}times1000 | u(16) |
| rd_{—}poly5_{—}k2_{—}times1000 | u(16) |
| } | |
| if( loc_radial_distortion_model==2 ) { | |
| rd_{—}ptl_{—}a_{—}times1000 | u(16) |
| rd_{—}ptl_{—}b_{—}times1000 | u(16) |
| rd_{—}ptl_{—}c_{—}times1000 | u(16) |
| } | |
| if( loc_radial_distortion_model==3 ) { | |
| rd_{—}acm_{—}k1_{—}times1000 | u(16) |
| rd_{—}acm_{—}k2_{—}times1000 | u(16) |
| rd_{—}acm_{—}k3_{—}times1000 | u(16) |
| rd_{—}acm_{—}k4_{—}times1000 | u(16) |
| rd_{—}acm_{—}k5_{—}times1000 | u(16) |
| } | |
| loc_{—}tca_{—}parameters_{—}present_{—}flag | u(1) |
| if( loc_{—}tca_{—}parameters_{—}present_{—}flag ) { | |
| loc_{—}tca_{—}model_{—}id | u(8) |
| if( loc_tca_model_id==0 ) { | |
| tca_{—}kr_{—}times1000 | u(16) |
| tca_{—}kb_{—}times1000 | u(16) |
| } | |
| if( loc_tca_model_id==1 ) { | |
| tca_{—}br_{—}times1000 | u(16) |
| tca_{—}cr_{—}times1000 | u(16) |
| tca_{—}vr_{—}times1000 | u(16) |
| tca_{—}bb_{—}times1000 | u(16) |
| tca_{—}cb_{—}times1000 | u(16) |
| tca_{—}vb_{—}times1000 | u(16) |
| } | |
| if( loc_tca_model_id==2 ) { | |
| tca_{—}alpha0_{—}times1000 | u(16) |
| tca_{—}alpha1_{—}times1000 | u(16) |
| tca_{—}alpha2_{—}times1000 | u(16) |
| tca_{—}alpha3_{—}times1000 | u(16) |
| tca_{—}alpha4_{—}times1000 | u(16) |
| tca_{—}alpha5_{—}times1000 | u(16) |
| tca_{—}beta0_{—}times1000 | u(16) |
| tca_{—}beta1_{—}times1000 | u(16) |
| tca_{—}beta2_{—}times1000 | u(16) |
| tca_{—}beta3_{—}times1000 | u(16) |
| tca_{—}beta4_{—}times1000 | u(16) |
| tca_{—}beta5_{—}times1000 | u(16) |
| } | |
| } | |
| loc_{—}vignetting_{—}parameters_{—}present_{—}flag | u(1) |
| if( loc_{—}vignetting_{—}parameters_{—}present_{—}flag ) { | |
| loc_{—}vignetting_{—}model_{—}id | u(8) |
| if( loc_vignetting_model==0 ) { | |
| vi_{—}pa_{—}k1_{—}times1000 | u(16) |
| vi_{—}pa_{—}k2_{—}times1000 | u(16) |
| vi_{—}pa_{—}k3_{—}times1000 | u(16) |
| } | |
| if( loc_vignetting_model==1 ) { | |
| vi_{—}acm_{—}alpha1_{—}times1000 | u(16) |
| vi_{—}acm_{—}alpha2_{—}times1000 | u(16) |
| vi_{—}acm_{—}alpha3_{—}times1000 | u(16) |
| } | |
| } | |
| } | |
| loc _{—}persistence_{—}flag | u(1) |
| } | |
| } | |

An SEI message following the syntax above could employ semantics as set forth below. The semantics definition below, again, follow the conventions used in ITU/MPEG standards, including the use of normative or informative language as defined by ITU/ISO/IEC for use in such standards.

This SEI message provides the decoder with a lens distortion model to enable image correction.

loc_cancel_flag equal to 1 indicates that the SEI message cancels the persistence of any previous lens optical correction SEI message in output order that applies to the current layer. loc_cancel_flag equal to 0 indicates that lens optical correction follows. loc_focal_parameters_present_flag equal to 1 indicates that focal parameters of the lens are present in the lens optical correction SEI message syntax. loc_focal_parameters_present_flag equal to 0 indicates that no focal parameter is present. loc_focal_center_x defines the horizontal location in the picture of the focal point. It is by default half of the width of the picture. loc_focal_center_y defines the vertical location in the picture of the focal point. It is by default half of the height of the picture. loc_focal_length defines the focal length of the lens, i.e., the distance from the lens in which rays of light that fall parallel to the optical axis into the lens are converged. It is expressed in millimeters and is set by default to 0, meaning it is unknown.

loc_radial_distortion_parameters_present_flag equal to 1 indicates that radial distortion parameters are present in the lens optical correction SEI message syntax. loc_radial_distortion_parameters_present_flag equal to 0 indicates that no radial correction is expected. loc_radial_distortion_model_id identifies the type of radial distortion model as specified in Table 1.

The value of loc_radial_distortion_model_id shall be in the range of 0 to 2, inclusive. The values greater than 3 are reserved for future use by ITU-T|ISO/IEC and shall not be present in bitstreams conforming to this version of this Specification. Decoders shall ignore lens optical correction SEI messages with loc_radial_distortion_model_id greater than 3.

TABLE 2
loc_radial_distortion_model_id

| Value | Description |
|---|---|
| 0 | Poly3 |
| 1 | Poly5 |
| 2 | Ptlens |
| 3 | ACM |

When loc_radial_distortion_model_id equals to 0 the polynomial 3^{rd} order model is specified as

$${r}_{d} = {r}_{u} ( 1 - {k}_{1} + {k}_{1} {r}_{u}^{2} ) \qquad Eq . 10$$

with r_{d} referring to the distorted radius (normalised distance to image center), rᵤ referring to the corrected undistorted radius, and k₁ being the distortion coefficient.

When loc_radial_distortion_model_id equals to 1 the polynomial 5^{th} order model is specified as

$${r}_{d} = {r}_{u} \cdot ( 1 + {k}_{1} {r}_{u}^{2} + {k}_{2} {r}_{u}^{4} ) \qquad Eq . 11$$

with r_{d} referring to the distorted radius (normalised distance to image center), rᵤ referring to the corrected undistorted radius, and k₁ and k₂ being the distortion coefficients.

When loc_radial_distortion_model_id equals to 2 the Ptlens model is specified as

$${r}_{d} = {r}_{u} \cdot ( {ar}_{u}^{3} + {br}_{u}^{2} + {cr}_{u} + 1 - a - b - c ) \qquad Eq . 12$$

with r_{d} referring to the distorted radius (normalised distance to image center), rᵤ referring to the corrected undistorted radius, and a, b and c being the distortion coefficients.

When loc_radial_distortion_model equals to 3 the ACM model is specified as

$${x}_{d} = {x}_{u} ( 1 + {k}_{1} {r}_{u}^{2} + {k}_{2} {r}_{u}^{4} + {k}_{3} {r}_{u}^{6} ) + 2 {x}_{u} ( {k}_{4} {y}_{u} + {k}_{5} {x}_{u} ) + {k}_{5} {r}_{u}^{2} , \\ {y}_{d} = {y}_{u} ( 1 + {k}_{1} {r}_{u}^{2} + {k}_{2} {r}_{u}^{4} + {k}_{3} {r}_{u}^{6} ) + 2 {y}_{u} ( {k}_{4} {y}_{u} + {k}_{5} {x}_{u} ) + {k}_{4} {r}_{u}^{2} , \\ with \\ {r}_{u}^{2} = {x}_{u}^{2} + {y}_{u}^{2} . \qquad Eq . 13$$

with (x_{d},y_{d}) being the coordinates of a point in the distorted image, (xᵤ,yᵤ) the coordinates of the same point in the undistorted image, and k₁, k₂, k₃, k₄, and k₅ referring the parameters of the radial distortion, being by default equal to 0.

rd_poly3_k1_times1000 indicates 1000 times the value of the k₁ parameter from the Poly3 radial distortion model. rd_poly3_k1_times1000 is comprised between −1000 and 1000 and is by default set to 0. rd_poly5_k1_times1000 indicates 1000 times the value of the k1 parameter from the Poly5 radial distortion model. rd_poly5_k1_times1000 is comprised between −1000 and 1000 and is by default set to 0. rd_poly5_k2_times1000 indicates 1000 times the value of the k1 parameter from the Poly5 radial distortion model. rd_poly5_k2_times1000 is comprised between −1000 and 1000 and is by default set to 0. rd_ptl_a_times1000 indicates 1000 times the value of the ‘a’ parameter from the Ptlens radial distortion model. rd_ptl_a_times1000 is comprised between −1000 and 1000 and is by default set to 0. rd_ptl_b_times1000 indicates 1000 times the value of the ‘b’ parameter from the Ptlens radial distortion model. rd_ptl_b_times1000 is comprised between −1000 and 1000 and is by default set to 0.

rd_ptl_c_times1000 indicates 1000 times the value of the ‘c’ parameter from the Ptlens radial distortion model. rd_ptl_c_times1000 is comprised between −1000 and 1000 and is by default set to 0. rd_acm_k1_times1000 indicates 1000 times the value of the k1 parameter from the ACM radial distortion model. rd_acm_k1_times1000 is comprised between −1000 and 1000 and is by default set to 0. rd_acm_k2_times1000 indicates 1000 times the value of the k2 parameter from the ACM radial distortion model. rd_acm_k2_times1000 is comprised between −1000 and 1000 and is by default set to 0.

rd_acm_k3_times1000 indicates 1000 times the value of the k3 parameter from the ACM radial distortion model. rd_acm_k3_times1000 is comprised between −1000 and 1000 and is by default set to 0. rd_acm_k4_times1000 indicates 1000 times the value of the k4 parameter from the ACM radial distortion model. rd_acm_k4_times1000 is comprised between −1000 and 1000 and is by default set to 0. rd_acm_k5_times1000 indicates 1000 times the value of the k5 parameter from the ACM radial distortion model. rd_acm_k5_times1000 is comprised between −1000 and 1000 and is by default set to 0.

loc_tca_parameters_present_flag equal to 1 indicates that transversal chromatic aberration parameters are present in the lens optical correction SEI message syntax. loc_tca_parameters_parameters_present_flag equal to 0 indicates that no transversal chromatic aberration correction is expected. loc_tca_model_id identifies the type of radial distortion model as specified in Table X. The value of loc_tca_model_id shall be in the range of 0 to 2, inclusive. The values greater than 2 are reserved for future use by ITU-T|ISO/IEC and shall not be present in bitstreams conforming to this version of this Specification. Decoders shall ignore lens optical correction SEI messages with loc_tca_model_id greater than 2.

TABLE 3
loc_tca_model_id

| Value | Description |
|---|---|
| 0 | Linear |
| 1 | Poly3 |
| 2 | ACM |

When loc_tca_model_id equals to 0 the linear model is specified as

$${r}_{d , R} = {r}_{u , R} {k}_{R} \\ {r}_{d , B} = {r}_{u , B} {k}_{B} \qquad Eq . 14$$

attributes are called “kᵣ” and “k_{b}”. They default to 1.

When loc_tca_model_id equals to 1 the linear model is specified as

$${r}_{d , R} = {r}_{u , R} \cdot ( {b}_{R} {r}_{u , R}^{2} + {c}_{R} {r}_{u , R} + {v}_{R} ) \\ {r}_{d , B} = {r}_{u , B} \cdot ( {b}_{B} {r}_{u , B}^{2} + {c}_{B} {r}_{u , B} + {v}_{B} ) \qquad Eq . 15$$

attributes are called “bᵣ”, “cᵣ”, “vᵣ”, “b_{b}”, “c_{b}”, and “v_{b}”. vᵣ and v_{b} default to 1.

When loc_tca_model_id equals to 2 the ACM model is specified as

$${x}_{d , R} = {α}_{0} ( ( 1 + {α}_{1} {r}_{u , R}^{2} + {α}_{2} {r}_{u , R}^{4} + {α}_{3} {r}_{u , R}^{6} ) {x}_{u , R} + 2 ( {α}_{4} {y}_{u , R} + {α}_{5} {x}_{u , R} ) {x}_{u , R} + {α}_{5} {r}_{u , R}^{2} ) , \\ {y}_{d , R} = {α}_{0} ( ( 1 + {α}_{1} {r}_{u , R}^{2} + {α}_{2} {r}_{u , R}^{4} + {α}_{3} {r}_{u , R}^{6} ) {y}_{u , R} + 2 ( {α}_{4} {y}_{u , R} + {α}_{5} {x}_{u , R} ) {y}_{u , R} + {α}_{4} {r}_{u , R}^{2} ) , \\ {x}_{d , B} = {β}_{0} ( ( 1 + {β}_{1} {r}_{u , B}^{2} + {β}_{2} {r}_{u , B}^{4} + {β}_{3} {r}_{u , B}^{6} ) {x}_{u , B} + 2 ( {β}_{4} {y}_{u , B} + {β}_{5} {x}_{u , B} ) {x}_{u , B} + {β}_{5} {r}_{u , B}^{2} ) , \\ {y}_{d , B} = {β}_{0} ( ( 1 + {β}_{1} {r}_{u , B}^{2} + {β}_{2} {r}_{u , B}^{4} + {β}_{3} {r}_{u , B}^{6} ) {y}_{u , B} + 2 ( {β}_{4} {y}_{u , B} + {β}_{5} {x}_{u , B} ) {y}_{u , B} + {β}_{4} {r}_{u , B}^{2} ) , \\ with \\ \\ {r}_{u , *} = √ {x}_{2 u , *} + {y}_{2 u , *} — — . \qquad Eq . 16$$

corresponding XML attributes are called “alpha0” to “alpha5”, and “beta0” to “beta5”. alpha0 and beta0 default to 1, the rest to 0.

tca_kr_times1000 indicates 1000 times the value of the kᵣ parameter from the linear transversal chromatic aberration model. kr_tca_times1000 is by default set to 1. tca_kb_times1000 indicates 1000 times the value of the k_{b} parameter from the linear transversal chromatic aberration model. kb_tca_times1000 is by default set to 1. tca_br_times1000 indicates 1000 times the value of the bᵣ parameter from the Poly3 transversal chromatic aberration model. tca_br_times1000 is by default set to 1. tca_cr_times1000 indicates 1000 times the value of the cᵣ parameter from the Poly3 transversal chromatic aberration model. tca_cr_times1000 is by default set to 1. tca_vr_times1000 indicates 1000 times the value of the vᵣ parameter from the Poly3 transversal chromatic aberration model. tca_vr_times1000 is by default set to 1. tca_bb_times1000 indicates 1000 times the value of the bb parameter from the Poly3 transversal chromatic aberration model. tca_br_times1000 is by default set to 1.

tca_cb_times1000 indicates 1000 times the value of the c_{b} parameter from the Poly3 transversal chromatic aberration model. tca_cr_times1000 is by default set to 1. tca_vb_times1000 indicates 1000 times the value of the v_{b} parameter from the Poly3 transversal chromatic aberration model. tca_vr_times1000 is by default set to 1. tca_alpha0_times1000 indicates 1000 times the value of the α₀ parameter from the ACM transversal chromatic aberration model. tca_alpha0_times1000 is by default set to 1. tca_alpha1_times1000 indicates 1000 times the value of the α₁ parameter from the ACM transversal chromatic aberration model. tca_alpha1_times1000 is by default set to 0.

tca_alpha2_times1000 indicates 1000 times the value of the α₂ parameter from the ACM transversal chromatic aberration model. tca_alpha2_times1000 is by default set to 0. tca_alpha3_times1000 indicates 1000 times the value of the α₃ parameter from the ACM transversal chromatic aberration model. tca_alpha3_times1000 is by default set to 0. tca_alpha4_times1000 indicates 1000 times the value of the α₄ parameter from the ACM transversal chromatic aberration model. tca_alpha4_times1000 is by default set to 0. tca_alpha5_times1000 indicates 1000 times the value of the α₅ parameter from the ACM transversal chromatic aberration model. tca_alpha5_times1000 is by default set to 0. tca_beta0_times1000 indicates 1000 times the value of the β₀ parameter from the ACM transversal chromatic aberration model. tca_beta0_times1000 is by default set to 1.

tca_beta1_times1000 indicates 1000 times the value of the β₁ parameter from the ACM transversal chromatic aberration model. tca_beta1_times1000 is by default set to 0. tca_beta2_times1000 indicates 1000 times the value of the β₂ parameter from the ACM transversal chromatic aberration model. tca_beta2_times1000 is by default set to 0. tca_beta3 times1000 indicates 1000 times the value of the β₃ parameter from the ACM transversal chromatic aberration model. tca_beta3_times1000 is by default set to 0. tca_beta4_times1000 indicates 1000 times the value of the β₄ parameter from the ACM transversal chromatic aberration model. tca_beta4_times1000 is by default set to 0. tca_beta5_times1000 indicates 1000 times the value of the β₅ parameter from the ACM transversal chromatic aberration model. tca_beta5_times1000 is by default set to 0.

loc_vignetting_parameters_present_flag equal to 1 indicates that vignetting parameters are present in the lens optical correction SEI message syntax.

loc_vignetting_parameters_present_flag equal to 0 indicates that no vignetting correction is expected. loc_vignetting_model_id identifies the type of vignetting model as specified in Table 3. The value of loc_vignetting_model_id shall be in the range of 0 to 1, inclusive. The values greater than 1 are reserved for future use by ITU-T|ISO/IEC and shall not be present in bitstreams conforming to this version of this Specification. Decoders shall ignore lens optical correction SEI messages with loc_vignetting_model_id greater than 1.

TABLE 4
loc_vignetting_model_id

| Value | Description |
|---|---|
| 0 | Palo D'Angelo model |
| 1 | ACM |

When loc_vignetting_model_id equals to 0 the Palo D'Angelo vignetting model is specified as

$${C}_{d} = {C}_{s} / ( 1 + {k}_{1} {r}^{2} + {k}_{2} {r}^{4} + {k}_{3} {r}^{6} ) \qquad Eq . 17$$

with C_{d} referring to the corrected destination image pixel brightness, Cₛ referring to the uncorrected source image pixel brightness, k₁, k₂ and k₃ referring to the polynomial parameters of the correction. k₁, k₂ and k₃ default to 0.

When loc_vignetting_model_id equals to 1 the ACM vignetting model is specified as

$${C}_{d} = {C}_{s} / ( 1 + {α}_{1} {r}^{2} + {α}_{2} {r}^{4} + {α}_{3} {r}^{6} ) \qquad Eq . 18$$

with C_{d} referring to the corrected destination image pixel brightness, Cₛ referring to the uncorrected source image pixel brightness, α₁, α₂ and α₃ referring to the parameters of the correction expressed in units of the focal length. α₁, α₂ and α₃ default to 0.

vi_pa_k1_times1000 indicates 1000 times the value of the k₁ parameter from the Palo D'Angelo vignetting model. vi_pa_k1_times1000 is by default set to 0. vi_pa_k2_times1000 indicates 1000 times the value of the k₂ parameter from the Palo D'Angelo vignetting model. vi_pa_k2_times1000 is by default set to 0. vi_pa_k3_times1000 indicates 1000 times the value of the k₃ parameter from the Palo D'Angelo vignetting model. vi pa k₃_times1000 is by default set to 0. vi_acm_alpha1_times1000 indicates 1000 times the value of the α₁ parameter from the ACM vignetting model. vi_acm_alpha1_times1000 is by default set to 0. vi_acm_alpha2_times1000 indicates 1000 times the value of the α₂ parameter from the ACM vignetting model. vi_acm_alpha2_times1000 is by default set to 0. vi_acm_alpha3_times1000 indicates 1000 times the value of the α₃ parameter from the ACM vignetting model. vi_acm_alpha3_times1000 is by default set to 0.

loc_persistence_flag specifies the persistence of the lens optical correction SEI message for the current layer. loc_persistence_flag equal to 0 specifies that the lens optical correction SEI message applies to the current decoded picture only. loc_persistence_flag equal to 1 specifies that the lens optical correction SEI message applies to the current decoded picture and persists for all subsequent pictures of the current layer in output order until one or more of the following conditions are true: (i) new CLVS of the current layer begins, (ii) the bitstream ends, (iii) a picture in the current layer in an AU associated with a lens optical correction SEI message is output that follows the current picture in output order.

Further, besides Table 1 above, Table 4 below shows another lens optical correction SEI message syntax according to one or more embodiments:

TABLE 4
lens optical correction SEI message syntax

| | Descriptor |
|---|---|
| lens_optical_correction( payloadSize ) { | |
| loc_{—}cancel_{—}flag | u(1) |
| if( !loc_cancel_flag ) { | |
| loc _{—}persistence_{—}flag | u(1) |
| loc_{—}lens_{—}model_{—}present_{—}flag | u(1) |
| if( loc_lens_model_present_flag ) { | |
| loc_{—}reserved_{—}zero_{—}5bits | u(5) |
| loc_{—}lens_{—}model | st(v) |
| } | |
| loc_{—}focal_{—}parameters_{—}present_{—}flag | |
| if( loc_focal_parameters_present_flag ) { | |
| loc_{—}focal_{—}center_{—}x | u(25) |
| loc_{—}focal_{—}center_{—}y | u(25) |
| loc_{—}focal_{—}length | u(16) |
| } | |
| loc_{—}rd_{—}parameters_{—}present_{—}flag | u(1) |
| if( loc_rd_parameters_present_flag ) { | |
| loc_{—}no_{—}rd | u(1) |
| if( !loc_no_rd ) { | |
| loc_{—}rd_{—}model_{—}id | u(8) |
| if( loc_rd_model_id = = 0 ) { | |
| loc_rd_poly3_k1 | i(25) |
| } | |
| if( loc_rd_model_id = = 1 ) { | |
| loc_{—}rd_{—}poly4_{—}k1 | i(25) |
| loc_{—}rd_{—}poly4_{—}k2 | i(25) |
| loc_{—}rd_{—}poly4_{—}k3 | i(25) |
| loc_{—}rd_{—}poly4_{—}k4 | i(25) |
| } | |
| if( loc_rd_model_id = = 2 ) { | |
| loc_{—}rd_{—}poly5_{—}k1 | i(25) |
| loc_{—}rd_{—}poly5_{—}k2 | i(25) |
| } | |
| } | |
| } | |
| loc_{—}tca_{—}parameters_{—}present_{—}flag | u(1) |
| if( loc_tca_parameters_present_flag ) { | |
| loc_{—}no_{—}tca | u(1) |
| if( !loc_no_tca ) { | |
| loc_{—}tca_{—}model_{—}id | u(8) |
| if( loc_tca_model_id = = 0) { | |
| loc_{—}tca_{—}kr | u(25) |
| loc_{—}tca_{—}kb | u(25) |
| } | |
| if( loc_tca_model_id = = 1 ) { | |
| loc_{—}tca_{—}br | i(25) |
| loc_{—}tca_{—}cr | i(25) |
| loc_{—}tca_{—}vr | u(25) |
| loc_{—}tca_{—}bb | i(25) |
| loc_{—}tca_{—}cb | i(25) |
| loc_{—}tca_{—}vb | u(25) |
| } | |
| } | |
| } | |
| loc_{—}vignetting_{—}parameters_{—}present_{—}flag | u(1) |
| if( loc_vignetting_parameters_present_flag ) { | |
| loc_{—}no_{—}vignetting | u(1) |
| if( !loc_no_vignetting ) { | |
| loc_{—}vignetting_{—}model_{—}id | u(8) |
| if( loc_vignetting_model_id = = 0 ) { | |
| loc_{—}vignetting_{—}k1 | i(25) |
| loc_{—}vignetting_{—}k2 | i(25) |
| loc_{—}vignetting_{—}k3 | i(25) |
| } | |
| } | |
| } | |
| } | |
| } | |

The following descriptions provide lens optical correction SEI message semantics regarding the syntax of embodiments herein such as with respect to above Table 4.

The Lens optical correction SEI message provides the decoder with a lens distortion model to enable image correction. When parameters for multiple distortion types are available in the lens optical correction SEI message, the parameters are expressed with intention for correction in the following sequential order: first de-vignetting (if present), then anti-TCA (if present), then reversing the radial distortion (if present).

According to embodiments, the parameters are expressed such that the corrections can be applied to samples in linear RGB format. Pictures represented with YUV sample data (such as Y′CbCr) can be converted to linear RGB in order to apply the lens corrections as intended.

The parameters of this SEI message apply to the cropped decoded picture.

When a frame packing arrangement SEI message is present in the CLVS, the parameters of this SEI messages apply to each constituent frame of the frame packing arrangement SEI message.

loc_cancel_flag equal to 1 indicates that the SEI message cancels the persistence of any previous lens optical correction SEI message in output order that applies to the current layer. loc_cancel_flag equal to 0 indicates that lens optical correction follows.

loc_persistence_flag specifies the persistence of the lens optical correction SEI message for the current layer. loc_persistence_flag equal to 0 specifies that the lens optical correction SEI message applies to the current decoded picture only. loc_persistence_flag equal to 1 specifies that the lens optical correction SEI message applies to the current decoded picture and persists for all subsequent pictures of the current layer in output order until one or more of the following conditions are true: (i) a new CLVS of the current layer begins, (ii) the bitstream ends, (iii) a picture in the current layer in an AU associated with a lens optical correction SEI message is output that follows the current picture in output order.

loc_lens_model_present_flag equal to 1 indicates that the loc_lens_model syntax element is present in the lens optical correction SEI message syntax.

loc_lens_model_present_flag equal to 0 indicates that the loc_lens_model syntax element is not present in the lens optical correction SEI message syntax. loc_reserved_zero_5bits shall be equal to 0 in bitstreams conforming to this version of this Specification. The values greater than 0 for loc_reserved_zero_5bits are reserved for future use by ITU-T|ISO/IEC. Decoders shall also allow values greater than 0 for loc_reserved_zero_5bits to appear in the bitstream and shall ignore the value of loc_reserved_zero_5bits. loc_lens_model specifies a string describing the applicable lens model. loc_focal_parameters_present_flag equal to 1 indicates that focal parameters of the lens are present in the lens optical correction SEI message syntax. loc_focal_parameters_present_flag equal to 0 indicates that no focal parameter is present

loc_focal_center_x÷2²⁴ defines the horizontal location in the picture of the focal point expressed as a ratio of the picture width. When not present, the value of loc_focal_center_x is inferred to be equal to 2²³ which corresponds to the center of the picture horizontally. The value of loc_focal_center_x shall be in the range of 0 to 2²⁴, inclusive. loc_focal_center_y÷2²⁴ defines the vertical location in the picture of the focal point expressed as a ratio of the picture height. When not present, the value of loc_focal_center_y is inferred to be equal to 2²³ which corresponds to the center of the picture vertically. The value of loc_focal_center_y shall be in the range of 0 to 2²⁴, inclusive. loc_focal_length defines the focal length of the lens, i.e., the distance from the lens in which rays of light that fall parallel to the optical axis into the lens are converged. It is expressed in units of 0.1 millimeters. A value of 0 indicates that the focal length is undefined. When not present, the value of loc_focal_length is inferred to be equal to 0.

loc_rd_parameters_present_flag equal to 1 indicates that radial distortion parameters are present in the lens optical correction SEI message syntax. loc_rd_parameters_present_flag equal to 0 indicates that radial distortion parameters are not present in the lens optical correction SEI message syntax. loc_no_rd equal to 1 indicates that there is no radial distortion. loc_no_rd equal to 0 indicates that radial distortion information is provided by the radial distortion parameters in the lens optical correction SEI message. loc_rd_model_id identifies the type of radial distortion model as specified in Table 1. The value of loc_rd_model_id shall be in the range of 0 to 2, inclusive. The values greater than 2 are reserved for future use by ITU-T|ISO/IEC and shall not be present in bitstreams conforming to this version of this Specification. Decoders shall ignore lens optical correction SEI messages with loc_rd_model_id greater than 2.

TABLE 5
loc_rd_model_id

| Value | Description |
|---|---|
| 0 | Poly3 |
| 1 | Poly4 |
| 2 | Poly5 |

When loc_rd_model_id equals to 0 the polynomial 3^{rd} order (Poly3) model is specified as

$${r}_{d} = {r}_{u} * ( 1 - {k}_{1} + {k}_{1} * {r}_{u} * {r}_{u} ) \qquad Eq . 19$$

with r_{d} referring to the distorted radius (normalized distance to image center), rᵤ referring to the corrected undistorted radius, and k₁ being the distortion coefficient.

When loc_rd_model_id equals to 1, the polynomial 4^{th} order (Poly4) model is specified as

$${r}_{d} = {r}_{u} * ( {k}_{1} + {k}_{2} * {r}_{u} + {k}_{3} * {r}_{u} * {r}_{u} + {k}_{4} * {r}_{u} * {r}_{u} * {r}_{u} ) \qquad Eq . 20$$

with r_{d} referring to the distorted radius (normalized distance to image center), rᵤ referring to the corrected undistorted radius, and k₁, k₂, k₃ and k₄ being the distortion coefficients.

Lenses with radial distortion information expressed using a three parameter formula of the form the r_{d}=rᵤ*(ar³ᵤ+br²ᵤ+crᵤ+1−a−b−c), can be signalled with Poly4 parameters by setting k₁=1−a−b−c, k₂=c, k₃=b, k₄=a.

When loc_rd_model_id equals to 2 the polynomial 5^{th} (Poly5) order model is specified as

$${r}_{d} = {r}_{u} * ( 1 - {k}_{1} * {r}_{u} * {r}_{u} + {k}_{2} * {r}_{u} * {r}_{u} * {r}_{u} * {r}_{u} ) \qquad Eq . 21$$

with rd referring to the distorted radius (normalized distance to image center), ru referring to the corrected undistorted radius, and k₁ and k₂ being the distortion coefficients.

loc_rd_poly3_k1÷2²⁴ indicates the value of the k₁ parameter from the Poly3 radial distortion model from equation (X-1). When not present, the value of loc_rd_poly3_k1 is inferred to be equal to 0. loc_rd_poly4_k1÷2²⁴ indicates the value of the k₁ parameter from the Poly4 radial distortion model from equation (X-2). When not present, the value of loc_rd_poly4_k1 is inferred to be equal to 0. loc_rd_poly4_k2÷2²⁴ indicates the value of the k₂ parameter from the Poly4 radial distortion model from equation (X-2). When not present, the value of loc_rd_poly4_k2 is inferred to be equal to 0. loc_rd_poly4_k3÷2²⁴ indicates the value of the k₃ parameter from the Poly4 radial distortion model from equation (X-2). When not present, the value of loc_rd_poly4_k3 is inferred to be equal to 0. loc_rd_poly4_k4÷2²⁴ indicates the value of the k₄ parameter from the Poly4 radial distortion model from equation (X-2). When not present, the value of loc_rd_poly4_k4 is inferred to be equal to 0. loc_rd_poly5_k1÷2²⁴ indicates the value of the k₁ parameter from the Poly5 radial distortion model from equation (X-2). When not present, the value of loc_rd_poly5_k1 is inferred to be equal to 0. loc_rd_poly5_k2÷2²⁴ indicates the value of the k₂ parameter from the Poly5 radial distortion model from equation (X-2). When not present, the value of loc_rd_poly5_k2 is inferred to be equal to 0. loc_tca_parameters_present_flag equal to 1 indicates that transversal chromatic aberration parameters are present in the lens optical correction SEI message syntax.

loc_tca_parameters_parameters_present_flag equal to 0 indicates that transversal chromatic aberration parameters are not present in the lens optical correction SEI message syntax. loc_no_tca equal to 1 indicates that there is no transversal chromatic aberration. loc_no_tca equal to 0 indicates that transversal chromatic aberration information is provided by the transversal chromatic aberration parameters in the lens optical correction SEI message. loc_tca_model_id identifies the type of radial distortion model as specified in Table 2. The value of loc_tca_model_id shall be in the range of 0 to 1, inclusive. The values greater than 1 are reserved for future use by ITU-T|ISO/IEC and shall not be present in bitstreams conforming to this version of this Specification. Decoders shall ignore lens optical correction SEI messages with loc_tca_model_id greater than 1.

TABLE 6
loc_tca_model_id

| Value | Description |
|---|---|
| 0 | Linear |
| 1 | Poly3 |

When loc_tca_model_id equals to 0 the linear model is specified as

$${r}_{d , R} = {r}_{u , R} * {k}_{R} \\ {r}_{d , B} = {r}_{u , B} * {k}_{B} \qquad Eq . 22$$

with r_{d,R} and r_{d,B} referring to the distorted radius (normalized distance to image center) of the red and blue components respectively, r_{u,R} and r_{u,B} referring to the corrected undistorted radius of the red and blue components respectively, and k_{R} and k_{B} being the transversal chromatic aberration coefficients of the red and blue components respectively.

The transversal chromatic aberration is corrected in the linear model on the red and blue components with the green component as the reference.

When loc_tca_model_id equals to 1 the polynomial 3^{rd} order (Poly3) model is specified as

$${r}_{d , R} = {r}_{u , R} * ( {b}_{R} * {r}_{u , R} * {r}_{u , R} + {c}_{R} * {r}_{u , R} + {v}_{R} ) {r}_{d , B} = {r}_{u , B} * ( {b}_{B} * {r}_{u , B} * {r}_{u , B} + {c}_{B} * {r}_{u , B} + {v}_{B} ) \qquad Eq . 23$$

with r_{d,R} and r_{d,B} referring to the distorted radius (normalized distance to image center) of the red and blue components respectively, r_{u,R} and r_{u,B} referring to the corrected undistorted radius of the red and blue components respectively, and {b_{R}, c_{R}, v_{R}} and {b_{B}, c_{B}, v_{B}} being the transversal chromatic aberration coefficients of the red and blue components respectively.

The transversal chromatic aberration is corrected in the Poly3 model on the red and blue components with the green component as the reference.

loc_tca_kr÷2²⁴ indicates the value of the kR parameter from the linear transversal chromatic aberration model from equation (X-3). When not present, the value of loc_tca_kr is inferred to be equal to 2²⁴. loc_tca_kb÷2²⁴ indicates the value of the kB parameter from the linear transversal chromatic aberration model from equation (X-4). When not present, the value of loc_tca_kr is inferred to be equal to 2²⁴. loc_tca_br÷2²⁴ indicates the value of the bp parameter from the Poly3 transversal chromatic aberration model from equation (X-5). When not present, the value of loc_tca_br is inferred to be equal to 0. loc_tca_cr÷2²⁴ indicates the value of the CR parameter from the Poly3 transversal chromatic aberration model from equation (X-5). When not present, the value of loc_tca_cr is inferred to be equal to 0. loc_tca_vr÷2²⁴ indicates the value of the VR parameter from the Poly3 transversal chromatic aberration model from equation (X-5). When not present, the value of loc_tca_vr is inferred to be equal to 2²⁴. loc_tca_bb÷2²⁴ indicates the value of the bp parameter from the Poly3 transversal chromatic aberration model from equation (X-6). When not present, the value of loc_tca_bb is inferred to be equal to 0. loc_tca_cb÷2²⁴ indicates the value of the CB parameter from the Poly3 transversal chromatic aberration model from equation (X-6). When not present, the value of loc_tca_cb is inferred to be equal to 0.

loc_tca_vb÷2²⁴ indicates the value of the VB parameter from the Poly3 transversal chromatic aberration model from equation (X-6). When not present, the value of loc_tca_vb is inferred to be equal to 2²⁴. loc_vignetting_parameters_present_flag equal to 1 indicates that vignetting parameters are present in the lens optical correction SEI message syntax. loc_vignetting_parameters_present_flag equal to 0 indicates that vignetting parameters are not present in the lens optical correction SEI message syntax. loc_no_vignetting equal to 1 indicates that there is vignetting. loc_no_vignetting equal to 0 indicates that vignetting information is provided by the vignetting parameters in the lens optical correction SEI message. loc_vignetting_model_id identifies the type of vignetting model as specified in Table 1. The value of loc_vignetting_model_id shall be equal to 0. The values greater than 0 are reserved for future use by ITU-T|ISO/IEC and shall not be present in bitstreams conforming to this version of this Specification. Decoders shall ignore lens optical correction SEI messages with loc_vignetting_model_id greater than 0.

TABLE 7
loc_vignetting_model_id

| Value | Description |
|---|---|
| 0 | Poly6 |

When loc_vignetting_model_id equals to 0, the polynomial 6^{th} order (Poly6) model is specified as

$${c}_{d} = {c}_{s} * ( 1 + {k}_{1} * {r}_{u} * {r}_{u} + {k}_{2} * {r}_{u} * {r}_{u} * {r}_{u} * {r}_{u} + {k}_{3} * {r}_{u} * {r}_{u} * {r}_{u} * {r}_{u} * {r}_{u} * {r}_{u} ) \qquad Eq . 24$$

with ca referring to the distorted colour, cₛ referring to the undistorted colour, rᵤ referring to the radius, and k₁, k₂ and k₃ being the vignetting distortion coefficients.

The same vignetting parameters are used for red, green and blue.

loc_vignetting_k1÷2²⁴ indicates the value of the k₁ parameter from the Poly6 vignetting model from equation (X-2). When not present, the value of loc_vignetting_k1 is inferred to be equal to 0. loc_vignetting_k2÷2²⁴ indicates the value of the k₂ parameter from the Poly6 vignetting model from equation (X-2). When not present, the value of loc_vignetting_k2 is inferred to be equal to 0. loc_vignetting_k3÷2²⁴ indicates the value of the k₃ parameter from the Poly6 vignetting model from equation (X-2). When not present, the value of loc_vignetting_k3 is inferred to be equal to 0.

As such, according to embodiments herein, an encoder may read a config file containing the Loc SEI parameters and insert the Loc SEI message into the bitstream. The decoder may parse the Loc SEI message from the bitstream, apply the radial distortion and/or the Transversal Chromatic Aberration corrections to the decoded video, and output the corrected video. Examples are described further below.

According to embodiments, the optical correction processing of the video is implemented into a class LensOpticalCorrection defined in LensOpticalCorrection.h/cpp as part of the CommonLib library. The LensOpticalCorrection::process function handles both the radial distortion and the TCA corrections. For the TCA correction a conversion to RGB (in BT.709) is done prior to applying the correction. The result is converted back to YUV. This is only meant to illustrate the functionality. For the radial distortion correction a bilinear filter is used, but here also, the purpose is to illustrate the feature, implementations using those correcting parameters may use more advanced filters.

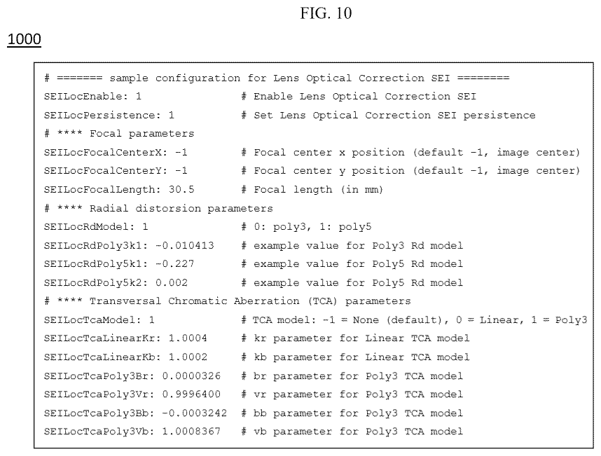

FIG. 10 illustrates an example 1000 of parameters from a config file as a sample configuration for lens optical correction SEI according to embodiments. On the encoder side, the lens optical correction configuration file is added by adding a-c option: EncoderApp-c cfg/encoder_lowdelay_vtm.cfg-i src.yuv-c cfg/sei_vui/lens_optical_correction.cfg. And outputting the lens corrected version is done as follows: DecoderApp-b str.bin-o output.yuv--SEILocFilename=‘loc_output.yuv’ for example.

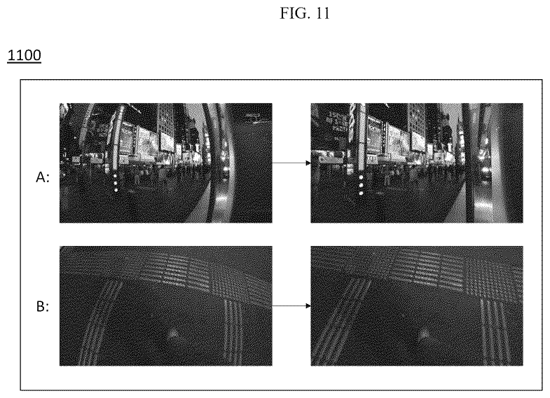

FIG. 11 illustrates examples 1100 of radial distortion correction being implemented according to embodiments herein. In example A of FIG. 11, radial distortion correction was applied using a Poly5 radial distortion model signaled in a Loc SEI message to obtain an output corrected video as follows:
SEILocEnable: 1
SEILocPersistence: 1
SEILocRdModel: 1 #0: poly3, 1: poly5
SEILocRdPoly5k1: −0.431
SEILocRdPoly5k2: 0.105

In example B of FIG. 11, radial distortion correction was applied using a Poly5 with the following parameters found and inserted into a Loc SEI message to obtain an output corrected video as follows:
SEILocEnable: 1
SEILocPersistence: 1
SEILocRdModel: 1 #0: poly3, 1: poly5
SEILocRdPoly5k1: −0.3204
SEILocRdPoly5k2: 0.1052

The decoder interpreting the parameters and applying them to the original video generated the corrected versions illustrated in FIG. 11.

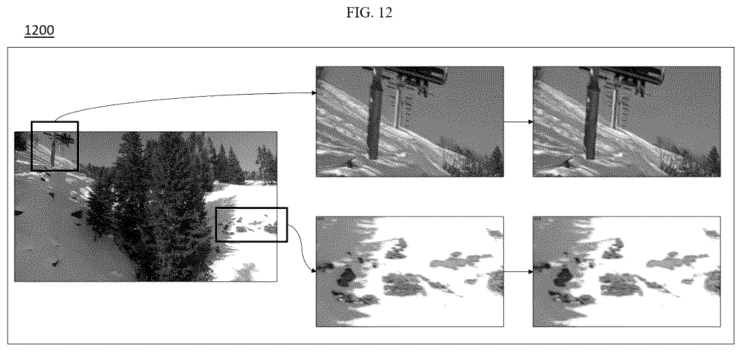

FIG. 12 illustrates an example 1200 of transversal chromatic aberration (TCA) correction being implemented according to embodiments herein. With regards to TCA, as shown in FIG. 12, a shot was selected with visible color fringing as can be understood at least from the above descriptions of color fringing with respect to FIG. 8A and FIG. 8B for example. And the 3rd order polynomial (Poly3) method was used to compensate the chromatic aberrations as follows:
SEILocEnable: 1
SEILocPersistence: 1
SEILocTcaModel: 1 #0: linear 1: poly3
SEILocTcaPoly3Br: −0.001
SEILocTcaPoly3Vr: 1.005
SEILocTcaPoly3Bb: 0.002
SEILocTcaPoly3Vb: 0.996

The results are shown with zooming on a couple of visible areas (original version on the left, corrected version on the right) in FIG. 12.

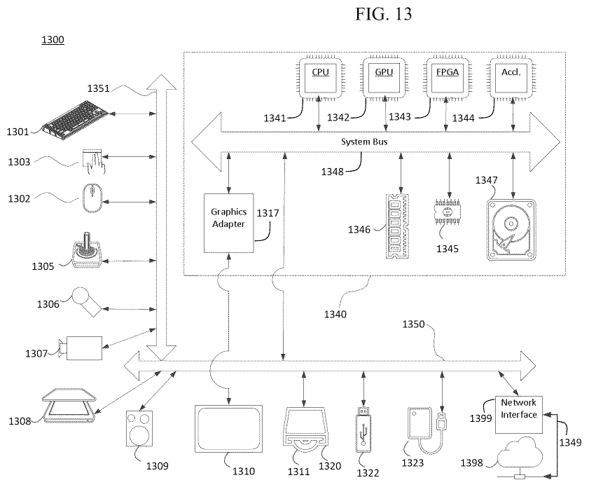

The techniques, such as those for Optical Correction SEI Message for Video Coding described above, can be implemented as computer software using computer-readable instructions and physically stored in one or more computer-readable media or by a specifically configured one or more hardware processors. For example, FIG. 13 shows a computer system 1300 suitable for implementing certain embodiments of the disclosed subject matter.

As such, by embodiments herein, there is provided methods, apparatus, and computer system for video encoding such video data and SEI messages such that there is also decoding by a decoder, comprising receiving, by the decoder, metadata associated with at least one picture indicative of an optical correction, wherein the metadata comprises at least one parameter required for at least one of an optical correction model.

The computer software can be coded using any suitable machine code or computer language, that may be subject to assembly, compilation, linking, or like mechanisms to create code comprising instructions that can be executed directly, or through interpretation, micro-code execution, and the like, by computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 13 for computer system 1300 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system 1300.

Computer system 1300 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 1301, mouse 1302, trackpad 1303, touch screen 1310, joystick 1305, microphone 1306, scanner 1308, camera 1307.

Computer system 1300 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 1310, or joystick 1305, but there can also be tactile feedback devices that do not serve as input devices), audio output devices (such as: speakers 1309, headphones (not depicted)), visual output devices (such as screens 1310 to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system 1300 can also include human accessible storage devices and their associated media such as optical media including CD/DVD ROM/RW 1320 with CD/DVD 1311 or the like media, thumb-drive 1322, removable hard drive or solid state drive 1323, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 1300 can also include interface 1399 to one or more communication networks 1398. Networks 1398 can for example be wireless, wireline, optical. Networks 1398 can further be local, wide-area, metropolitan, vehicular and industrial, real-time, delay-tolerant, and so on. Examples of networks 1398 include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks 1398 commonly require external network interface adapters that attached to certain general-purpose data ports or peripheral buses (1350 and 1351) (such as, for example USB ports of the computer system 1300; others are commonly integrated into the core of the computer system 1300 by attachment to a system bus as described below (for example Ethernet interface into a PC computer system or cellular network interface into a smartphone computer system). Using any of these networks 1398, computer system 1300 can communicate with other entities. Such communication can be uni-directional, receive only (for example, broadcast TV), uni-directional send-only (for example CANbusto certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core 1340 of the computer system 1300.

The core 1340 can include one or more Central Processing Units (CPU) 1341, Graphics Processing Units (GPU) 1342, a graphics adapter 1317, specialized programmable processing units in the form of Field Programmable Gate Areas (FPGA) 1343, hardware accelerators for certain tasks 1344, and so forth. These devices, along with Read-only memory (ROM) 1345, Random-access memory 1346, internal mass storage such as internal non-user accessible hard drives, SSDs, and the like 1347, may be connected through a system bus 1348. In some computer systems, the system bus 1348 can be accessible in the form of one or more physical plugs to enable extensions by additional CPUs, GPU, and the like. The peripheral devices can be attached either directly to the core's system bus 1348, or through a peripheral bus 1351. Architectures for a peripheral bus include PCI, USB, and the like.

CPUs 1341, GPUs 1342, FPGAs 1343, and accelerators 1344 can execute certain instructions that, in combination, can make up the aforementioned computer code. That computer code can be stored in ROM 1345 or RAM 1346. Transitional data can be also be stored in RAM 1346, whereas permanent data can be stored for example, in the internal mass storage 1347. Fast storage and retrieval to any of the memory devices can be enabled through the use of cache memory, that can be closely associated with one or more CPU 1341, GPU 1342, mass storage 1347, ROM 1345, RAM 1346, and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, an architecture corresponding to computer system 1300, and specifically the core 1340 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 1340 that are of non-transitory nature, such as core-internal mass storage 1347 or ROM 1345. The software implementing various embodiments of the present disclosure can be stored in such devices and executed by core 1340. A computer-readable medium can include one or more memory devices or chips, according to particular needs. The software can cause the core 1340 and specifically the processors therein (including CPU, GPU, FPGA, and the like) to execute particular processes or particular parts of particular processes described herein, including defining data structures stored in RAM 1346 and modifying such data structures according to the processes defined by the software. In addition or as an alternative, the computer system can provide functionality as a result of logic hardwired or otherwise embodied in a circuit (for example: accelerator 1344), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for video decoding in a decoder, the method comprising:
receiving a video bitstream comprising at least one picture of a video and a supplementary enhancement information (SEI) message associated with the at least one picture;
obtaining, from the SEI message, metadata indicating one or more parameters of an optical correction to be applied to the at least one picture; and
decoding and applying the optical correction to the picture based on the one or more parameters of the optical correction.

2. The method according to claim 1,
wherein the SEI message comprises lens optical correction (loc) SEI message syntax of “lens_optical_correction”.

3. The method according to claim 2,
wherein the metadata indicates that the one or more parameters of the optical correction are to be applied based on any of radial distortion, chromatic aberration, and vignetting of the picture.

4. The method according to claim 3,
wherein the loc SEI message syntax further comprises a plurality of flags each respectively indicating whether the optical correction comprises correction to radial distortion, chromatic aberration, and vignetting.

5. The method according to claim 1,
wherein the SEI message indicates a first focal center of the picture along a first axis, a second focal center of the picture along a second axis, and a focal length.

6. The method according to claim 5,
wherein the SEI message further indicates a lens model.

7. The method according to claim 1,
wherein the SEI message further indicates a set of parameters, including the one or more parameters, of at least one model by which the optical correction is to be applied to the at least one picture.

8. A method of video encoding, the method comprising:
receiving a video comprising at least one picture;
determining an optical correction to be applied to the at least one picture; and
encoding the at least one picture and a supplementary enhancement information (SEI) message associated with the at least one picture, the SEI message indicating one or more parameters of an optical correction to be applied to the at least one picture.

9. The method according to claim 8,
wherein the SEI message comprises lens optical correction (loc) SEI message syntax of “lens_optical_correction”.

10. The method according to claim 9,
wherein the metadata indicates that the one or more parameters of the optical correction are to be applied based on any of radial distortion, chromatic aberration, and vignetting of the picture.

11. The method according to claim 10,
wherein the loc SEI message syntax further comprises a plurality of flags each respectively indicating whether the optical correction comprises correction to radial distortion, chromatic aberration, and vignetting.

12. The method according to claim 8,
wherein the SEI message indicates a first focal center of the picture along a first axis, a second focal center of the picture along a second axis, and a focal length.

13. The method according to claim 12,
wherein the SEI message further indicates a lens model.

14. The method according to claim 8,
wherein the SEI message further indicates a set of parameters, including the one or more parameters, of at least one model by which the optical correction is to be applied to the at least one picture.

15. A method of processing visual media data, the method comprising:
performing a conversion between a visual media file and a bitstream of a visual media data according to a format rule, the format rule indicating to:
determine one or more parameters of an optical correction to be applied to the at least one picture of a video, and
to determine the one or more parameters based on a supplementary enhancement information (SEI) message associated with the at least one picture.

16. The method according to claim 15,
wherein the SEI message comprises lens optical correction (loc) SEI message syntax of “lens_optical_correction”.

17. The method according to claim 16,
wherein the metadata indicates that the one or more parameters of the optical correction are to be applied based on any of radial distortion, chromatic aberration, and vignetting of the picture.

18. The method according to claim 17,
wherein the loc SEI message syntax further comprises a plurality of flags each respectively indicating whether the optical correction comprises correction to radial distortion, chromatic aberration, and vignetting.

19. The method according to claim 15,
wherein the SEI message indicates a first focal center of the picture along a first axis, a second focal center of the picture along a second axis, and a focal length, and
wherein the SEI message further indicates a lens model.

20. The method according to claim 15,
wherein the SEI message further indicates a set of parameters, including the one or more parameters, of at least one model by which the optical correction is to be applied to the at least one picture.
